(19) United States
(12) Patent Application Publication
(10) Pub. No.: US 2005/0102226 A1
(43) Pub. Date: May 12, 2005

(54) System and method of accounting for mortgage related transactions

(76) Inventors: Dror Oppenheimer, Potomac, MD (US); Maryann Bastnagel, Potomac, MD (US); Michael A. Quinn, Potomac, MD (US); John L. Kemper, Vienna, VA (US); John A. Simonds JR., Durham, NC (US)

Correspondence Address: FANN-MKE C/O;FOLEY & LARDNER, 777 EAST WISCONSIN AVENUE, MILWAUKEE, WI, 53202-5367, US

(21) Appl. No.: 11/015,844

(22) Filed: Dec. 16, 2004

Related U.S. Application Data
(63) Continuation-in-part of application No. 10/738,737, filed on Dec. 17, 2003.
(60) Provisional application No. 60/533,311, filed on Dec. 30, 2003.
(60) Provisional application No. 60/436,630, filed on Dec. 30, 2002.

(51) Int. Cl. G06F 17/60

(52) U.S. Cl. 705/38; 705/39

(57) ABSTRACT

The present description relates to a system and method of accounting for a mortgage related transaction comprises receiving data related to the mortgage related transaction, the mortgage related transaction being defined using a combination of attributes, and comparing the combination of attributes that define the transaction with a database of attribute combinations to determine the accounting treatment of the transaction.

### CROSS-REFERENCE TO RELATED APPLICATIONS

This application claims the benefit under 35 U.S.C. § 119(e) of U.S. Provisional Patent Application Ser. No. 60/533,311, entitled “System and M ethod of Accounting for Mortgage Related Transactions,” filed on Dec. 30, 2003, which is expressly incorporated herein by reference in its entirety. This application is further a continuation in part of U.S. patent application Ser. No. 10/738,737, entitled “System and Method for Defining Loan Products,” filed on Dec. 17, 2003, pending, which claims priority under 35 U.S.C. § 119(e) to U.S. Provisional Patent Application Ser. No. 60/436,630, entitled “System and Method for Defining Loan Products,” filed on Dec. 30, 2002, both of which are expressly incorporated herein by reference in their entireties.

### FIELD OF THE INVENTION

This description relates to computer systems and methods used to process data pertaining to financial instruments, such as loans, securities, and so on. In particular, this description relates to computer systems and methods used to perform accounting functions for mortgage related transactions (e.g., originating and/or servicing mortgages, securitizing mortgages, etc.).

### BACKGROUND OF THE INVENTION

The introduction of the mortgage backed security (MBS) has made the dream of owning a home possible for a much larger number of individuals. Frequently, when a borrower takes out a loan to purchase a home, that loan is subsequently pooled with other loans and used to create an MBS. The MBS is an investment instrument that can be sold to investors on Wall Street. Upon sale of the MBS, lenders can turn around and make new loans using proceeds from the sale. In effect, the MBS is a way for Wall Street to provide capital for loans to fund home ownership. The increased availability of capital reduces interest rates as compared to the interest rates that would otherwise be available, and therefore makes home ownership more affordable for an increased number of individuals.

While the mortgage backed security approach has worked exceptionally well, home ownership rates could be further improved if loans could be used to create new forms of mortgage backed securities and/or other types of investment instruments or other assets that more optimally align with investor needs. A more optimal alignment would result in further increases in the availability of capital, further reductions in interest rates, and ultimately increased home ownership rates.

In addition to providing new types of investment instruments, it is also desirable to provide new types of loan products. Different borrowers are in different financial situations and have different financial needs. Providing new types of loan products to meet these needs is a further way of increasing home ownership rates. Some of these new loan products may not coincide with the current structure for mortgage backed securities. Often, users of the current structure must balance between the interests of borrowers and the interests of investors. A more flexible structure for the creation, maintenance, and accounting of investment instruments and loan products is needed.

Efforts to offer new types of investment instruments and new types of loan products have been hampered by the fact that current data processing systems for processing loan information (including information on both the borrower side and on the investor side of the process) are not sufficiently efficient and flexible. Modifying the data processing system to support a new type of loan product or a new type of investment instrument is very difficult and expensive. In many cases, inherent limitations in the architecture of such data processing systems make certain types of new loan products or new investment instruments impossible to offer as a practical matter.

For example, in connection with modifying a data processing system to support a new type of loan product, such modifications are often very difficult because current data processing systems are designed around a very limited number of common, standard products, such as a fixed-rate 30-year mortgage. As a result, the data processing systems have rigid data structures and protocols that are only configured to handle certain types of information pertinent to such products. If a new customized product is offered, current data processing systems have to be modified and configured with new logic to enable the new product to be processed and handled. For example, a new product that includes a change in a cash flow structure may require unique processing necessitating significant changes to the cash processing system design. In practice, this amounts to having largely separate data processing systems for each separate product that is offered.

Therefore, a need exists for computer systems and methods that are capable of providing increased flexibility in defining, processing, and maintaining new types of loan products and investment instruments.

### SUMMARY OF THE INVENTION

According to one embodiment a method of accounting for a mortgage related transaction comprises receiving data related to the mortgage related transaction, the mortgage related transaction being defined using a combination of attributes, and comparing the combination of attributes that define the transaction with a database of attribute combinations to determine the accounting treatment of the transaction.

According to another embodiment a method of accounting for a mortgage related transaction comprises receiving data pertaining to the mortgage related transaction. The mortgage related transaction being defined as a combination of attributes. The combination of attributes of the transaction is compared to an accounting matrix which comprises a plurality of groups and a plurality of values for each group. The combination of attributes of the transaction are used to determine a corresponding combination of groups and/or values for each group in the accounting matrix. The transaction is classified based on the results of comparing the attributes of the transaction to the accounting matrix.

According to another embodiment, a data processing system for processing data regarding a plurality of different types of transactions is provided. The data processing system being configured to receive a plurality of types of transactions. The types of transactions each comprising a combination of attributes. The data processing system classifies the transactions for accounting purposes by comparing the attributes to a database which comprises a combinations of attributes.

According to another embodiment, a data processing system for processing data regarding mortgage related transactions is provided. The system comprises an accounting matrix which includes groups of accounting relevant transaction attributes and/or loan attributes and accounting logic which determines the attributes of a mortgage related transaction and maps the attributes to the groups in the accounting matrix. The groups including values representing the attributes and each combination of groups and values is associated with at least one of a debit account and a credit account. The accounting logic uses the map of the attributes to the groups to classify the transaction for accounting purposes.

### BRIEF DESCRIPTION OF THE DRAWINGS

FIG. 1 is a block diagram of a data processing system according to a preferred embodiment of the present invention;

FIG. 2 is a block diagram showing user services logic of the system of FIG. 1 in greater detail;

FIGS. 3A-3B are block diagrams showing underwriting logic, acquisition logic, servicer and investor reporting logic, and securitization logic of the system of FIG. 1 in greater detail;

FIG. 4 is a block diagram showing common services logic of FIG. 1 in greater detail; and

FIG. 5 is an exemplary data map used in connection with packeting logic in the system of FIG. 1.

FIG. 6 is a flow diagram of a process for processing an attribute-based loan product; and

FIGS. 7A and 7B are flow diagrams of processes for creating an attribute-based loan product.

FIG. 8 is a block diagram showing book and tax accounting logic of the system of FIG. 1 in greater detail.

FIG. 9 is one embodiment of an accounting matrix that is used to determine the accounting treatment of various mortgage transactions.

FIGS. 10A-10E are screen shots showing various families and family members used to map the attributes of mortgage transactions to determine the proper accounting treatment.

FIG. 11 is a screen shot showing a family that may be used in the accounting matrix and selected family members for that may be included as part of the family.

FIGS. 12A-12E are screen shots showing various family members of selected families, which may be included in the accounting matrix.

FIGS. 13-15 are various screen shots of a user interface that may be used to modify the accounting matrix.

FIGS. 16-17 are screen shots showing ledger posting details for a number of transactions.

FIG. 18 is a screen shot of a notification list generated using the accounting logic.

FIG. 19 is a screen shot of a user interface that may be used to reconcile the sub-ledger and the general ledger accounts.

FIG. 20 is a screen shot of an accounting console which is included in the accounting logic.

FIGS. 21-29 are diagrams illustrating one process for accounting for transactions using the accounting matrix.

### DETAILED DESCRIPTION OF THE PREFERRED EMBODIMENT

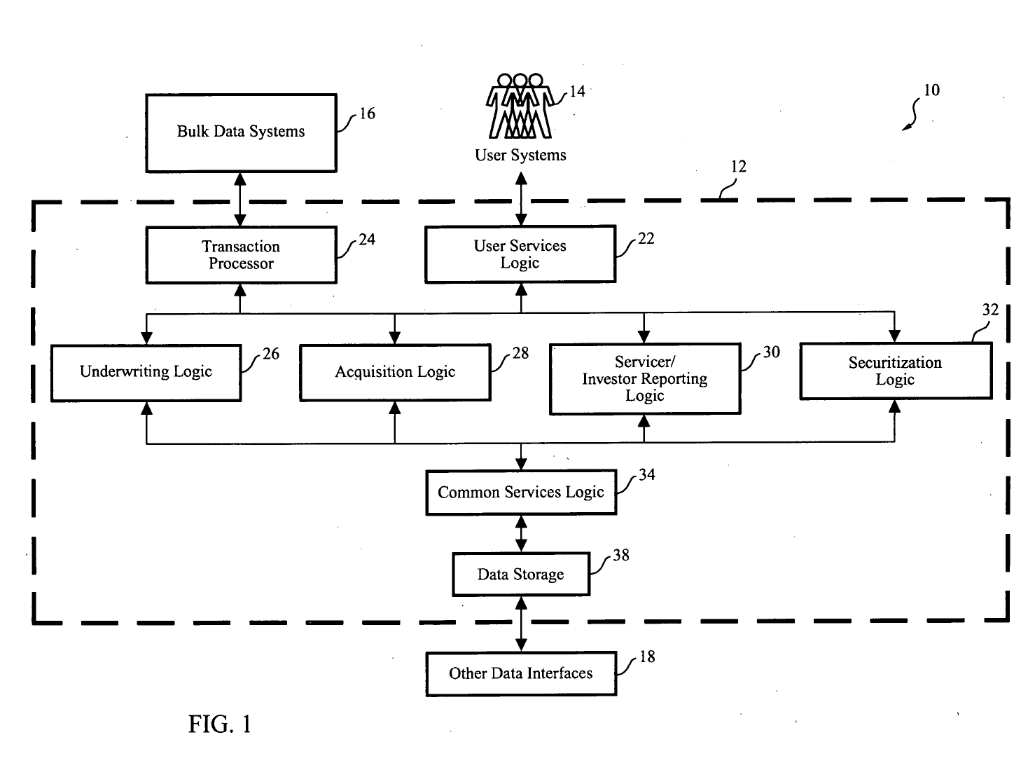

Referring now to FIG. 1, a computer system 10 for processing data pertaining to financial assets is shown. As shown in FIG. 1, the system 10 comprises a data processing system 12, user systems 14, bulk data systems 16, and other data interfaces 18. The data processing system 12 further comprises user services logic 22, a transaction exchange processor 24, underwriting logic 26, acquisition logic 28, servicer and investor reporting logic 30, securitization logic 32, common services logic 34, a data storage system 38, and other data interfaces 36. Herein, although the term “logic” is used in connection with some blocks and the term “pro cessor” is used in connection with other blocks, these two terms are used interchangeably. The term “proc essor” is used in the generic sense and is not meant to imply a separate discrete unit of processing hardware.

The data processing system 12 is configured for processing data pertaining to financial assets, such as loans and securities. In one embodiment, the data processing system 12 is configured to be used by a participant in the secondary mortgage market. Herein, for convenience, the participant is referred to as a “purchaser,” although it should be understood that the purchaser may participate in the secondary market in other, different, or additional ways (e.g., as a loan guarantor, as a loan securitizer, and so on).

The data processing system 12 is preferably usable to support various types of transactions which may be executed by such a purchaser in connection with one or more loans. For example, the purchaser may purchase loans from lenders or other loan originators as part of a cash execution. The purchased loans may, for example, be held as investments in the purchaser's inv estment portfolio. Alternatively, the purchaser may create mortgage backed securities (MBS) as part of an MBS execution, or create other financial instruments or assets that are collaterallized by cash flows associated with individual loans, including both loans that have been purchased by the purchaser and other loans that have not been purchased by the purchaser. For example, in the case of MBS, the purchaser may acquire a pool of loans, securitize the pool of loans to create MBS that is then sold to investors, and hold the pool of loans in trust for the benefit of the investors. The purchaser may also receive a fee for guaranteeing to holders of MBS or other financial instruments the repayment of the loans by borrowers. The purchaser may also use loans to create other types of financial assets or instruments, for example, by purchasing loans and selling the financial instruments to investors, or by performing such services for other owners of loan assets.

The acquisition logic 28 is preferably usable to perform such operations as receiving information such as loan term, interest rate, principal owed and other parameters regarding loans when loans are first purchased or otherwise acquired and entered into the data processing system 12. In the case of cash executions, the acquisition logic 28 is also used to perform such operations as receiving commitments for the purchased loans.

The servicer and investor reporting logic 30 is used to process periodic loan data for loan accounting purposes and generate accounting output in connection with the purchased loans. Herein, the terms “reporting lo gic” and “servic er and investor reporting logic” are used interchangeably and both refer to logic that is configured to perform loan accounting and generate accounting output (e.g., for purposes of investor reporting, for purposes of managing a loan portfolio, and so on) in connection with a plurality of loans. The servicer and investor reporting logic 30 preferably performs such functions as receiving loan payment data on an ongoing basis from third party servicers. In this regard, it may be noted that the servicer and investor reporting logic 30 in the illustrated embodiment is not used for servicing loans directly but rather interfaces with a third party servicer. Of course, the servicer and investor reporting logic 30 could also be configured to include additional logic for servicing loans, either as part of the servicer and investor reporting logic 30 or as part of another functional block. The accounting output generated by the servicer and investor reporting logic 30 may include such things as accounting, tax, performance/valuation, and/or other relevant financial information for the loans retained in the portfolio or sold, in whole or in part.

The securitization logic 32 is used to generate financial assets. Herein, the terms “financi al asset generation logic” and “se curitization logic” are used interchangeably and refer to any logic that is used to generate/create financial assets. Herein, the term “fin ancial asset” is used generically to refer to any asset that is backed by one or more cash flows, and includes such things as assets that are created entirely for internal data tracking purposes (e.g., in the case of packets which do not represent securities), as well as assets that have external significance (e.g., in the case of MBS or other security). The securitization logic 32 may be used to generate financial assets such as MBS or assets that are tracked internally in situations where the owner/operator of the data processing system 12 purchases a pool of loans and holds the loans as an investment in its own portfolio.

It will be appreciated that the data processing system 12 may perform fewer or additional functions as compared to those described herein. For example, an entity that performs only some of the above-mentioned processes may use a computer system that contains only a subset of the functions described herein. Herein, it will be assumed that the data processing system 12 is used to support each of the business processes described above.

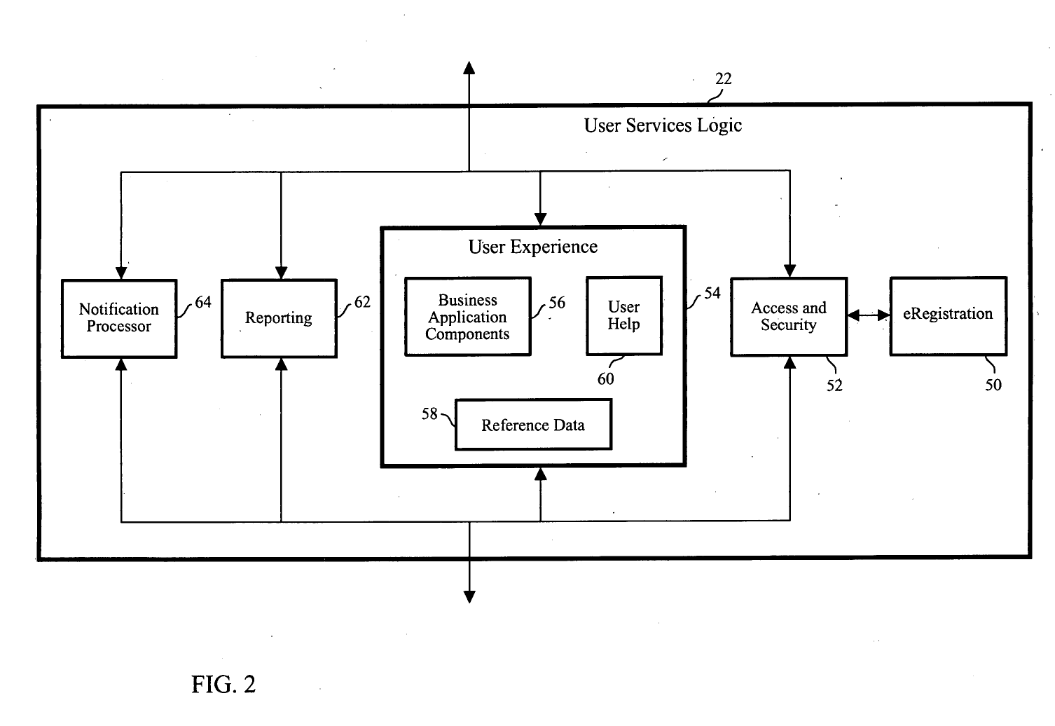

Generally speaking, in the illustrated embodiment, there are three access points for external systems into the data processing system 12. Access can include data flow into and out of system 12. A first access point into the data processing system 12 is the user services logic 22 which provides entry to the user systems 14. A preferred implementation of the user services logic 22 is described in greater detail below in connection with FIG. 2. For purposes of explanation, the user systems 14 are assumed to be operated by human users that participate in some way in the above mentioned business processes. For example, the human user may be an employee of a lender or other loan originator that uploads loan information to the purchaser (or corrects, updates, and so on, information that has previously been provided) in connection with committing to deliver or actually delivering a group of loans to the purchaser, an employee of an owner of a portfolio of loans that uploads loan information in connection with a group of loans the owner wishes to have securitized by the purchaser, an employee of a servicer that uploads payment information regarding a group of loans serviced by the servicer, an employee of an institutional investor that downloads information regarding the financial performance or other data regarding investment instruments created and maintained by the purchaser, an employee of the purchaser itself, and so on.

A second access point into the data processing system 12 is the transaction exchange processor 24 which provides entry to the bulk data systems 16. The transaction exchange processor provides an alternative, bulk transfer mechanism for exchanging at least some of the transaction-related data mentioned above in connection with the user systems 14, typically without intervention of a human operator. Such bulk data transfers may occur with lenders, servicers, and so on. The transaction exchange processor 24 receives/sends transactions, and prescreens/sorts/translates data if needed, and makes the transactions/data available for further processing in the data processing system 12 or outbound transmission. A third access point into the data processing system 12 is through the data interfaces 18. The data interfaces 18 may be used to exchange other types of data between other computer systems and the data processing system 12. For example, the data interfaces 18 may be used to import or export data to other external computer systems (that is, computer systems not under the control of the purchaser) or other internal computer systems (e.g., computer systems that are under the control of the purchaser but that provide functionality that is not integrated into the data processing system 12).

The data processing system 12 is described in greater detail below in connection with FIGS. 2-5. As will become apparent from the discussion below, the preferred data processing system 12 exhibits a high level of data, service and time granularity. With respect to data granularity, the system 12 is capable of decomposing loans into a series of highly granular cash flows and tracking all of the cash flows from the point the cash flows enter the data processing system 12 (e.g., as part of a loan payment or other cash flow source) to the point the cash flows exit the data processing system 12 (e.g., as part of a payment on a financial instrument). The decomposition of a particular loan into sub-loan cash flows may occur when the loan is first acquired, later when servicing activity begins on the loan, or at another time. When loan payments are received, the allocation of the loan payment into individual cash flows may be performed by logic executed by the servicer, by the data processing system 12, or by other logic. Ideally, all or nearly all of the cash flow sources associated with a particular loan can be identified and tracked. Additionally, it is also possible to aggregate cash flows from a borrower perspective or other entity perspective. For example, a series of loans (e.g., all to the same borrower) may be aggregated into a higher order cash flow and then the aggregation of the loans may be decomposed. It is also possible to add cash flows to existing loans, for example, so that a new cash flow (e.g., for a new line of credit) may be established without having to set up a new loan. This provides additional flexibility to modify a borrower's loan over time. Thus, the data processing system 12 not only decomposes and maps cash flows associated with such things as principal and borrower paid interest, but also sub-loan level cash flows arising in association with the borrower paid interest or fees associated with the loan such as servicing fees, guarantee fees, mortgage insurance, prepayment penalties, borrower-paid fees, servicer advances, servicer recoveries, and loss/default components, and provides other flexibility. Additional description regarding exemplary possible sources of cash flows is provided at the end of this section. The decomposition and mapping of cash flows dramatically increases the number of different types of financial instruments that may be created, because it makes it possible to create financial instruments based on these other cash flows. In turn, this makes it possible to create financial instruments that are more optimally configured to meet the needs of the owner of the financial instrument.

With respect to service granularity, the data processing system 12 represents loans as a series of attributes and uses a business rules engine to process loan information. This dramatically simplifies the process of expanding the capabilities of the data processing system 12 to process data associated with any type of loan. The capability to process a new type of loan may be added by adding an additional attribute to a list of attributes corresponding to the new product feature (or modifying existing attributes), by using the attribute to indicate the presence or absence (and/or other characteristics) of the new feature in a particular loan, and by modifying the rules engine to incorporate additional rules regarding the new loan feature. It is not necessary to build a completely new data processing system for the new type of loan. This makes it easier to offer new types of loans which are more optimally configured to meet the needs of individual borrowers. An exemplary set of attributes is described at the end of this section.

With respect to time granularity, the data processing system 12 is capable of processing data using a much smaller time slice or update period than has been possible in the past. In the past, systems have typically been constructed around the assumption that servicers provide monthly reports which summarize loan activity that occurred during the previous month. The time slice for reporting has been one month and sub-monthly temporal data has been lost. In the data processing system 12, when information regarding new loans is received by the acquisition logic 28 and/or when information regarding loan payments is received by the servicer and investor reporting logic 30, this information preferably includes information regarding the date the loan was acquired, the date or dates within each month or other period on which a payment or other transaction is expected, and/or the date the payment was received. The time slice in the data processing system 12 is therefore one day (or less, if a smaller time slice such as AM/PM, hour, minutes, seconds, and so on, is used). The temporal information is stored and maintained in databases which are synchronized/commonly accessible by the acquisition logic 28, the servicer and investor reporting logic 30, and the securitization logic 32. As a result, the acquisition logic 28, the servicer and investor reporting logic 30, and the securitization logic 32 each have access to this highly granular temporal information regarding loan acquisitions and payments. The increased time granularity supports the above-mentioned capabilities to offer a wider array of loans to borrowers and a wider array of financial instruments to investors. For example, the increased time granularity facilitates offering loan products in which the borrower is expected to make bi-weekly payments, which may be attractive to borrowers that get paid bi-weekly instead of twice-monthly or monthly. This also facilitates handling loan products in which the date of a transaction is meaningful, such as daily simple interest loans. Further, because sub-loan cash flows can be processed using a one day time slice (or less), it is possible to create financial instruments based on cash flows that are processed on a per day basis.

Another benefit of the acquisition logic 28, the servicer and investor reporting logic 30, and the securitization logic 32 being provided on a common platform and having access to common/synchronized databases is that each system has an up to date view of the data. As previously indicated, the data processing system 12 has the ability to accept payment and other transaction information from a servicer as such transactions occur (e.g., using daily, hourly, or near real-time updates) instead of or in addition to receiving end of the month summary transaction information from the servicer. Once the data is received, it is accessible throughout the data processing system 12. For example, it is not necessary to limit the data updates for the securitization logic to a once-per-month basis at the end of a servicing cycle. Therefore, an up to date view of the data is available throughout the data processing system 12.

It should be apparent that it is also possible to construct data processing systems which do not incorporate the advantages described herein in connection with the data processing system 12, or which also incorporate additional advantages not described herein. Further, it may also be noted that the separation of functionality shown in FIGS. 1-4 is necessarily to some extent conceptual, and it is also possible to provide the same functionality in other ways. Additionally, although numerous functions are described below, it may be noted that it may be desirable to provide fewer, additional, or different functions in a given data processing system depending on the application and what is needed.

Referring now to FIG. 2, a preferred implementation of the user services logic 22 and subcomponents thereof will now be described. The user services logic 22 includes electronic registration logic 50, access and security logic 52, user experience logic 54, report request processing logic 62, and a notification processor 64. The registration logic 50 is used to register individual users to be able to use the data processing system 12. For example, an employee of a lender may be given a login name and password to access the data processing system 12. User registration preferably includes providing each user with an authorization profile that defines the extent and type of access the user is given to the data processing system 12 and the types of operations that the user may perform while accessing the data processing system 12. The access and security logic 52 cooperates with the electronic registration logic 50 to permit users to access the data processing system 12 in the manner authorized.

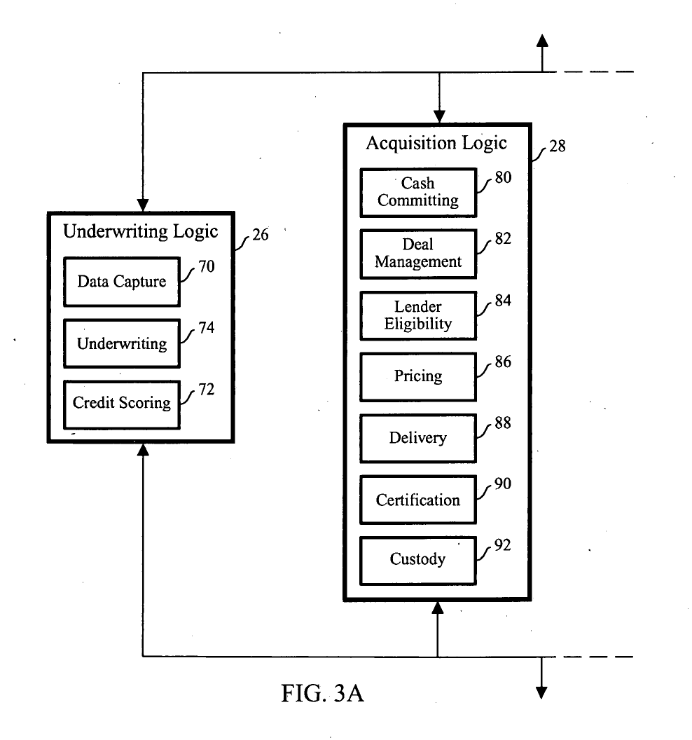

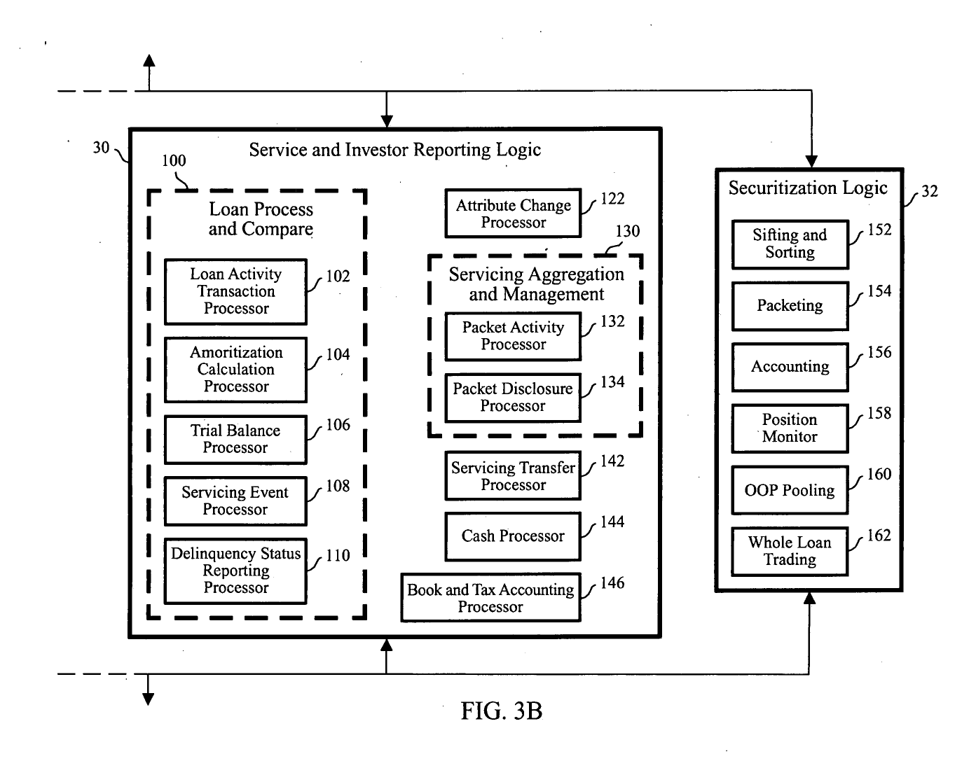

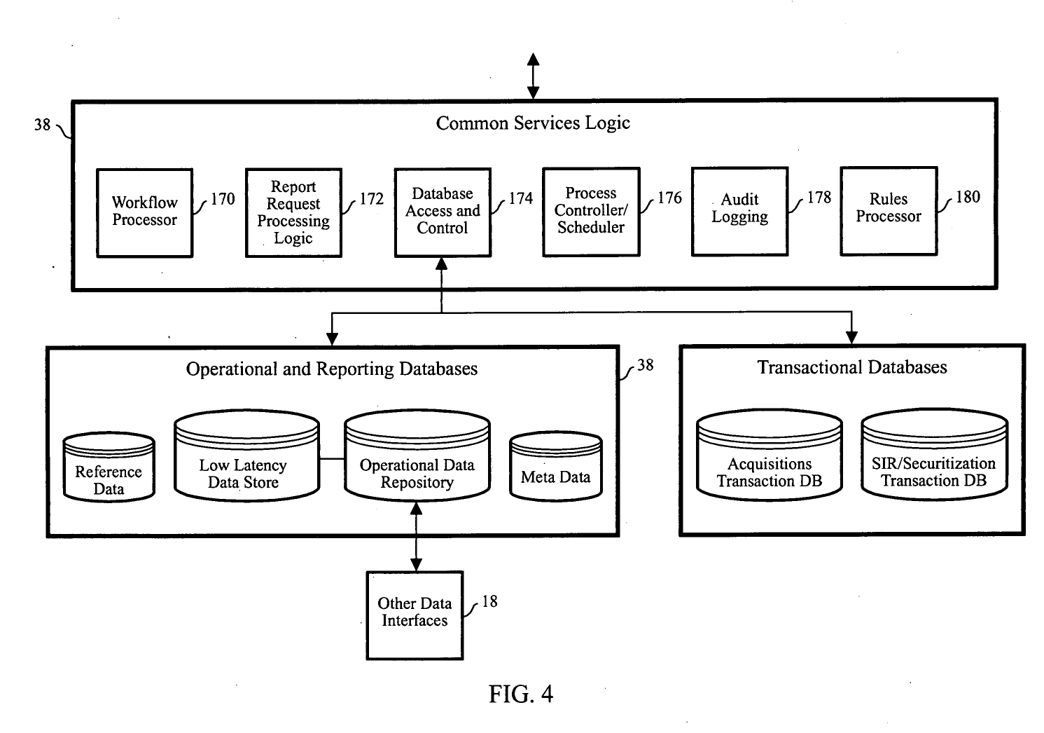

The user experience logic 54 provides a user interface to the data processing system 12. Preferably, the user accesses the data processing system 12 through the Internet or an Intranet by using a personal/laptop computer or other suitable Internet-enabled device. For example, the data processing system 12 may be accessible to users by visiting the purchaser's web site (th at is, the web site of the entity that owns/operates the data processing system 12, and that is assumed to be in the business of purchasing, guaranteeing, and/or securitizing loans) and clicking on appropriate links located at the web site. Depending on the authorizations the user has been given in the registration logic 50, the user is able to access different web pages of the web site relating to the underwriting logic 26, the acquisition logic 28, the servicer and investor reporting logic 30, and the securitization logic 32. For example, there may be one or more web pages relating to acquisitions that may be accessed by lenders, one or more pages relating to servicing that may be accessed by servicers, and so on. The user may then perform functions in accordance with what is permitted by the user's authorization profile (which, in turn, is typically based on the user's employ er and the user's job function for that employer). For example, an employee of a lender may be given authorization to access web pages associated with the acquisition logic 28 and commit the lender to deliver a quantity of loans on a future date (i.e., to engage in a forward commitment with the purchaser). The types of operations that different users may perform is described in greater detail in connection with FIGS. 3A, 3B and 4 below.

The user experience logic 54 includes business application components 56, reference data 58, and user help logic 60. These components provide implementation support to the above-described user interface. The business application components 56 includes logic that assists directing the user to the correct web page. The reference data 58 may include data regarding user preferences for the appearance of web pages to the user. The reference data 58 may also provide general reference data and content that assists user interaction with the web site. The reference data 58 may also include data regarding particular lenders, such as the year the lender was first approved to do business with the purchaser, contact information for the lender, and performance information such as statistics and transfer history for the lender. The user help logic 60 provides other help or “How To” components.

The user services logic 22 also includes report request processing logic 62 and a notification processor 64. The report request processing logic 62 permits lenders and servicers to access the data processing system 12 and request reports generated from the data the lenders or servicers have provided the purchaser. The reports may be predefined “canned” reports, or may be ad hoc reports defined by the user by drilling down into the data and/or defining data filters. The type of reporting generation capability available may be made dependent on the type of user. The report request processing logic 62 may be used for incoming data in connection with lenders and servicers and/or for outgoing data in connection with investor reporting. Investor reporting may also be handled by other logic described below.

The notification processor 64 sends notifications/alerts to users. For example, the notification processor 64 may be used to send e-mail (or fax, automated telephone call, and so on) to a user associated with a servicer or lender indicating that data which has been submitted by the servicer or lender has been processed, and that the processed data is ready for review. The notification processor 64 is useful in the context of exceptions processing, when lender/servicer data is processed but the processing indicates that there may be an error in the lender's/s ervicer's data which requires review by a human operator.

Referring now to FIG. 3A, a preferred implementation of the underwriting logic 26 and subcomponents thereof will now be described. The underwriting logic 26 is typically accessed by users that originate loans, such as lenders and brokers. The underwriting logic 26 includes data capture logic 70, underwriting logic 74, and credit scoring logic 72. The data capture logic 70 is used to receive information to be used in loan underwriting and appraisal (e.g., information from a loan application and a credit report). Typically, the information that is received for loan underwriting is a subset of the information that would be provided on a loan application. The credit scoring logic 72 and the underwriting logic 74 cooperate to analyze the information to determine if the loan meets credit risk and eligibility requirements of the purchaser, and then issue a recommendation based on the assessment of the overall risk profile of the loan. The credit scoring logic 72 generates a credit score of the loan applicant based on the loan applicant's cr edit history. The underwriting logic 74 then combines the credit score with other information (e.g., debt-to-income ratios, appraisal value, income verification, borrower contribution, cash reserves of the borrower, the existence and amount of subordinate financing, and other factors) to determine whether to approve loan eligibility. The underwriting logic 26 may also be used to generate reports that provide information regarding the underwriting recommendation for a particular loan, information used in determining the recommendation (e.g., property, loan, and borrower information), and information summarizing key statistics from the credit report (e.g., borrower's open accounts, derogatory accounts, and undisclosed accounts).

Still referring to FIG. 3A, a preferred implementation of the acquisition logic 28 and subcomponents thereof will now be described. The acquisition logic 28 further includes cash committing logic 80, deal management logic 82, lender eligibility logic 84, pricing logic 86, delivery logic 88, certification logic 90, and custody logic 92.

The cash committing logic 80 provides a facility for performing all cash commitment functions. Typically, a master agreement/contract may be in place between the purchaser and the lender which defines overall terms of loan sales to the purchaser pursuant to particular commitments. A cash commitment is an agreement (typically, governed by the overall master agreement) in which the mortgage purchaser agrees to buy mortgages from mortgage sellers (e.g., lenders) in exchange for a specified price in cash. Typically, a cash commitment agreement specifies the type of mortgage(s) the seller plans to deliver, the amount of time the seller has to make delivery, the price the mortgage purchaser will pay the seller for the loan(s), other pertinent loan terms, and, in some cases, loan level details pertaining to the mortgage.

The cash committing logic 80 provides a central point for approved lenders (or other approved sellers) and the purchaser to perform all cash commitment functions. These functions may include, for example, making standard forward commitments, handling pair-off of commitments, extending commitments, over-delivering of a commitment, maintaining configurable parameters, updating contact information, updating commitment records, viewing and selecting from a seller's favorite product list, adding to and maintaining the seller's f avorite product list, viewing contracts, fees, prices, yield adjustments, and so on. As previously described, the access and security logic 52 verifies the identity of the user (using a login ID and password) and allows the user to gain access to the cash committing logic 80. Different types of users may be granted different levels of access to the cash commitment logic 80 (e.g., for different employees within a seller organization having different levels of authority to act on behalf of the seller).

In the preferred embodiment, the system 12 includes the ability to limit the different types of loans that a given seller may sell to a subset of the loans which the purchaser may purchase. The different products may comprise loans of different terms, different interest rates and types of interest rates (fixed or variable), as well as a variety of other features or combinations of features that may be offered in connection with the particular mortgage products. This information may be stored in the lender eligibility logic 84, described below, and the cash committing logic 80 may interface with the lender eligibility logic 84 to limit commitment activity to only those products that the seller is eligible to sell. During the committing process, the seller selects the type of product the seller plans to deliver from a list of eligible products. Sellers may be provided the ability to flag any eligible product as a “f avorite,” and are able to select products from a favorites list when making commitments. Preferably, sellers are also provided with the option to assign their own marketing name for each eligible product in the seller's favorites list. In another embodiment, rather than selecting from a list of eligible products, sellers may be provided the ability to define a product they plan to deliver by defining the loan attributes.

The committing logic 80 provides sellers with the option to apply a commitment to a master agreement. Information regarding master agreements is supplied by the deal management logic 82 and displayed in the cash committing logic 80 for a given seller. The display may, for example, indicate valid master agreement numbers, the unfulfilled commitment amount in dollars for each master agreement, the expiration date for each master agreement, and/or other pertinent information.

The deal management logic 82 is used to store and track terms of the deals/contracts made between sellers of loans and the purchaser. When a seller contacts the purchaser to initiate negotiation of a new deal, an employee or other representative of the purchaser uses the deal management logic 82 to create a master agreement, MBS pool contract and all the associated variances.

During the master agreement negotiation process, all terms and stipulations of the agreement are entered into the deal management logic 82. The deal management logic 82 enables authorized users creating or modifying variances to identify editable variances and facilitates transforming “co deable” variances into business rules in the delivery logic. The deal management logic 82 also facilitates communication of these variances to users responsible for analyzing them. Users responsible for analyzing variances are provided a link to the edit engine where they are able to add, modify, or delete edits based on their analyses.

The deal management logic 82 also integrates with the pricing logic 86 so that loan level yield adjustments that reflect negotiated variances may be entered and displayed in the generated master agreement. The seller's specific adjustment tables (referencing master agreement and variance reference numbers) may also be stored in the deal management logic or, more preferably, in the lender eligibility logic 84.

The lender eligibility logic 84 is logic that maintains information regarding the eligibility of particular lenders to offer particular products made available by the purchaser. The lender eligibility logic 84 allows users (via web interface) to maintain and update product or lender-specific parameters in connection with the committing logic 80, the delivery logic 88, the certification logic 90, the custody logic 92, and the servicer and investor reporting logic 30. The lender eligibility logic 84 may also be used to set pricing incentive adjustments, other yield adjustments, fees and other parameters at the lender and product levels.

The pricing logic 86 is the logic used to generate pricing information and provide the pricing information to other logic in the data processing system 12, including the underwriting logic 26, the committing logic 80, the delivery logic 88, the certification logic 90, the custody logic 92, and the servicer and investor reporting logic 30. For example, the pricing logic 86 may be accessed during delivery to determine the price to be paid for a particular loan, or after the loan is delivered to determine how changes/corrections in loan information affect pricing. The pricing logic 86 takes into account pricing elements such as commitment/interest price (based on interest and the type of commitment), commitment calculations (e.g., for yield adjustments associated with pair-offs, over delivery, extensions), and credit adjustment price (based on loan level credit risk). In addition to cash pricing (i.e., pricing in situations where the loan is paid in cash), the pricing logic 86 may also be used for MBS pricing (i.e., pricing in situations where the loan is paid for using a mortgage backed security). The pricing elements related to a MBS include the guarantee fee, the buy-up/buy-down amount, and the credit adjustment amount.

The pricing logic 86 interacts with the delivery logic 88 (described in greater detail below) when a seller is unable to fulfill the terms of its original commitment to generate yield adjustments associated with pair-offs, over delivery, and extensions. The pricing logic 86 acquires delivery and under delivery tolerance amounts from the lender eligibility logic 84, processes data from a commitment inventory database to locate expired commitments and under deliveries, based on input from the delivery logic. The pricing logic 86 also processes data associated with the original commitment parameters to generate yield adjustments. Additionally, yield adjustments may also be assessed at the time of delivery for credit risk in connection with one or more loans that exceeds a pre-determined and agreed-upon level. In particular, at the time a cash commitment or MBS deal is made, a certain level of credit risk is assumed when determining the cash price or MBS guarantee fee. Later, when loans are actually delivered, the true risk level is identified. If the cash price or MBS guarantee fee does not account for this actual level of risk, a yield adjustment is made. The system allows the option of selecting either an upfront loan level yield adjustment at the time of delivery or a guarantee fee basis point adjustment to permit the payment to be made over time.

The pricing logic 86 also interacts with the servicer and investor reporting logic 30 when there are loan level changes during the servicing of the loan that result in a request for pricing. The servicing logic 28 sends the pertinent data attributes needed for pricing to the pricing logic 28 and the pricing logic 86 returns pricing information for the loan in question.

The pricing logic 86 may also be used to access prices set forth in pricing grids that store pricing information as a function of various loan parameters and/or features, e.g., interest rate and remaining term in connection with a particular seller. The pricing grids may be generated manually (e.g., in a spreadsheet which is provided to the pricing logic 86) or automatically. The pricing logic 86 may also be used to generate reports regarding pricing information.

The delivery logic 88 is the logic used to process loans when loans are delivered to the purchaser in connection with a purchase. The delivery logic 88 analyzes loan attributes, the associated deal/contract with the seller, and execution parameters to determine if the loan is acceptable for submission under the terms and conditions of the deal. The delivery logic 88 also invokes the pricing logic 86 to determine the price and/or yield adjustments associated with accepting the loan. The delivery logic 88 also allows sellers to set up pools in cases where the loans are pooled in MBS.

The delivery logic 88 receives electronic loan data by way of the user services logic 22 or the transaction exchange processor 24. The purchaser will generally also receive paper loan documents that support the electronic loan data received by the data processing system 12.

The delivery logic 88 utilizes aspects of the underwriting logic 26, the deal management logic 82, and the pricing logic 86. Each loan that is delivered is checked against business rules and data format rules. Business rules are based on the product, pool/piece/contract, pricing, commitment, and other factors. For example, a seller may inadvertently try to deliver a 15-yr loan in connection with a commitment for 30-yr loans, and the business rules provide a mechanism for identifying that the 15-yr loan can not be used to satisfy that commitment. The delivery logic 88 uses the notification processor 64 to notify the seller when/if the data that is being delivered does not match the commitment. The delivery logic 88 also cooperates with the underwriting logic 26 to confirm that the loans that are being delivered meet underwriting criteria. Sellers are notified using the notification processor 64 when underwriting decisions for a particular loan is different than was anticipated based on the original (typically, incomplete or incorrect) loan data and there is an impact to the price that the seller will be charged. The pricing logic 86 is invoked to determine the change in price.

The delivery logic 88 allows the user to edit the delivery data for format/field edits and standard/custom edits necessary to deliver loans to the purchaser. Users have a real time view of updates to the delivery data in order to resolve data errors before the loan is purchased or securitized. For example, if the data indicates that a 15-yr loan is being used to satisfy a commitment for a 30-yr loan, the user may edit the data to indicate that the loan is a 30-yr loan (in a situation where the loan data was incorrectly entered and what was originally indicated as being a 15-yr loan is in fact a 30-yr loan). Alternatively, the user may edit the data to instead apply the 15-yr loan to a different commitment for a 15-yr loan. As a further alternative, the user may edit the data to substitute a 30-yr loan for the 15-yr loan. The delivery logic 88 also includes logic for address correction (detecting erroneous address information and correcting the address information) and geographic coding (to provide additional geographic information on the property, such as longitude and latitude, tract, congressional district, metropolitan statistical area number, and so on). By the end of the process, the delivery logic also generates a unique loan number for each of the loans for tracking purposes.

The certification logic 90 is logic that supports the process of ensuring that all loan documentation is complete and legally binding and that the paper documentation matches the electronic information delivered by the seller. The certification logic 90 generates, stores and makes available to other aspects of the data processing system 12 information pertaining to which loans have been certified. The certification logic 90 is also able to generate custom reports regarding certification data including reports on loans that have not been certified so that appropriate action may be taken (e.g., having the seller repurchase the loan). The certification logic 90 facilitates data modification and facilitates data matching when loans are redelivered or resubmitted. The certification logic 90 also generates reports to support management decisions with respect to certification activities.

The custody logic 92 is logic that is used to support the custody process, or the process whereby the purchaser stores the paper loan documents during the time from when the loans are purchased or securitized until they are released. Custody protects the physical evidence of investment in negotiable assets. The custody logic 92 manages custodial profile/contact information, custodian/seller relationships, and seller/servicer profile/eligibility information related to custody activities. The custody logic 92 also permits information to be retrieved regarding loan investors. If the market purchaser performs the custody function itself rather than having a third party act as custodian, the custody logic 92 also supports document management in connection with incoming and outgoing documents. In particular, the custody logic 92 tracks when loan documents are in the possession of the purchaser and otherwise manages and monitors the position of the physical loan documents. The custody logic 92 also manages and calculates fees charged for custodial and certification services.

The acquisition logic 28 may also include other logic in addition to the logic described above. For example, the acquisition logic 28 may further include payable/receivable manager logic to track the billing of yield adjustments and fees generated by transactions in the committing logic 80, the pricing logic 86, the delivery logic 88, the custody logic 92, and certain aspects of the servicer and investor reporting logic 30. The payable/receivable manager logic may also be used to display the status (including payment status) of such yield adjustments and fees in a consolidated manner.

Referring now to FIG. 3B, a preferred implementation of the servicer and investor reporting logic 30 will now be described in greater detail. The servicer and investor reporting logic 30 includes loan process and compare (LPC) logic 100, which monitors and verifies the activities of third party mortgage servicers on an ongoing basis. Alternatively, if servicing is performed internally by the owner of the data processing system 12 and is included as part of the servicer and investor reporting logic 30 or as part of another functional block of the data processing system 12, the LPC logic 100 may be used to verify internally generated reporting information. Thus, the LPC logic 100 performs such operations as receiving and validating reporting information pertaining to loan activity, loan delinquency information and unpaid balance comparison reported by the servicer, updating the records of the data processing system 100 regarding the status of all reported loans, and determining the remittance and disbursement amounts that are expected for the loans.

As an initial matter, prior to loan servicing, a comparison is performed of the servicer's d ata for loans being serviced with the purchaser's d ata for the same loans. Even if the purchaser's d ata has already been compared with lender data for the same group of loans, the servicer's dat a may for some reason be different. Accordingly, the purchaser may provide a predefined set of acquisition data to the servicer that the servicer can compare with the servicer's d ata. At any time thereafter, the servicer may perform individual queries of the loan data stored on the purchasers data base via the user services logic 22 (web interface) and download the data for further comparison purposes. When exceptions are noted, the servicer can correct its data or submit a change request via the user interface to the attribute change processor (ACP) logic 122, described below.

During the life of the loan, when loan activity occurs (e.g., when the borrower makes loan payments), the LPC logic 100 is executed with regard to a particular loan when a servicer reports transactions to the purchaser. A loan activity processor 102 handles expected and scheduled servicing transactions including payments, rate changes, curtailments, and so on. The activity processor 102 receives and validates loan transaction data, such as loan activity, unpaid balance comparison, and delinquency status updates. The activity processor 102 also can be configured to check for duplicate transactions, validate servicer information, determine and validate the type of loan transaction, and validate that the loan activity is being reported in the correct reporting period. The activity processor 102 also confirms that changes in unpaid balance and last paid installment are correct, derives expected interest remittance, derives expected principal remittance, and compares the derived amounts to the reported remittance amounts. After validation, the status of the loan is made available to the servicer through the user services logic 22. The activity processor 102 also triggers the appropriate cash and accounting transactions in a book and tax accounting processor 146. When loan activity is processed and does not match the purchasers expectations based on rules and calculations, exceptions are noted and communicated to users using the notification processor 64.

The amortization/calculation processor 104 is used by the activity processor 102 to calculate loan level amounts, such as principal and interest due, servicing fees and other data pertinent to each loan. Processor 104 may additionally be used to compute derived or decomposed cash flows, such as a guaranty fee or a servicing fee. Business rules are used to identify scheduled and unscheduled principal, calculate fees, calculate remittance and disbursement amounts, calculate amounts to be disbursed to investors, amortization, and accruals. These calculations are used throughout the system 12 to perform functions such as collecting remittances from servicers, dispersing funds to investors and performing accounting activities. The results of processing are available through an interactive user interface to both personnel of the purchaser and personnel of the servicer for correction when transactions do not comply with business rules.

The trial balance processor 106 provides for validation of parameters such as servicer number, purchaser and servicers loan numbers, effective date, ending unpaid balance, note rate, pass through rate, principal and interest payment, last paid installment (LPI) date, pool number, accrued interest receivable balance, available line of credit, conversion date, reverse mortgage payment, net principal limit, taxes and insurance set asides, property charges set asides, repairs set asides, servicing fees set asides, scheduled payments, and so on. Any discrepancies are resolved and any system updates (loan attribute changes, data updates) are implemented. The LPC logic 100 then reprocesses the activity based on the corrected data.

In addition to borrower payments, the LPC logic 100 may also be triggered with regard to a particular loan when the attribute change processor (ACP) logic 122 makes a change to attributes that affect loan processing or when a loan attribute triggers processing, such as note rate changes, payment changes and loan reporting. The LPC logic 100 may also be triggered by borrower behavior (e.g., loan delinquencies status) at beginning and end of accounting periods.

The servicing event processor 108 identifies and handles business events that are not identified by the activity processor 102. Examples of these events include identifying delinquent loans and identifying loans that are eligible for reclassification or substitution. The delinquency status reporting processor 1 10 accepts delinquency reasons from the servicer for loans that have payments that are in arrears.

The attribute change processor (ACP) logic 122 processes loan or security level changes. The ACP logic 122 processes attribute changes regarding loans. As previously described, in the preferred embodiments, loans are characterized in the data processing system 12 by a series of attributes rather than by product codes. Each mortgage product that is purchased is then represented by a series of attributes instead of or in addition to an overall product code. New products may be created by creating new combinations of attributes, or by adding new attributes. An exemplary list of possible attributes that may be used is provided at the end of this section.

The ACP logic 122 processes attribute changes that occur after loans are brought into the data processing system 12. In particular, after loans are brought into the data processing system 12, the ACP logic 122 processes attribute changes that are unexpected or are unscheduled whereas the LPC logic 100 handles attribute changes that are both expected and scheduled. The ACP logic 122 also validates the attribute change request, assesses the financial impact of the change, updates the appropriate data and triggers the appropriate cash and accounting transactions.

Unexpected attribute changes are changes that are required due to new features or discrepancies between contract documentation and data captured by the acquisition logic 26, this can include changes to loan data and/or changes in loan behavior. Unscheduled attribute changes are changes that may occur based on contract documentation but the timeframe is unknown. For example, an unexpected attribute change would be a change for a daily simple interest cash loan that the purchaser has purchased without knowledge of a particular feature. After the purchase, the borrower exercises options under the feature and the servicer advances the next due date of the loan and submits a loan activity transaction record to the purchaser. Not knowing about the feature, the purchaser rejects the transaction since the loan record does not indicate the presence of the feature. After assessing the exception and evaluating the change, the servicer submits an attribute change request to add this feature and keep the loan in the purchaser's portfolio or in the security, pending confirmation of continued loan eligibility. An example of an unexpected and unscheduled attribute change would be the case where the lender submits an adjustable rate mortgage change request for a loan that the purchaser has set up as a fixed rate mortgage. The request is processed as an unscheduled change because the purchaser's systems have never had an event scheduled to trigger the change. An example of an unscheduled change is a fixed rate convertible loan which has the conversion option indicated in the terms of the note. It is anticipated that an attribute change will occur but the timing of the event is unknown and therefore unscheduled. The two primary types of unexpected attributed changes are post purchase adjustments (data corrections) and modifications (attribute changes driven by a number of business requirements, such as product flexibility, delinquency management, and substitutions/reclassifications).

In operation, the ACP logic 122 receives attribute change requests which indicate current database values for the loan and the proposed changes. The validation of the loan with the new values is then accomplished by applying the rules processor 180 to the ACP transaction. The business rules engine is applied to determine whether the changes are allowable and any failed business rules are provided to an operator for further review. Next, the original terms of the contract are used to determine any pricing adjustments of the attribute change. The system determines the difference between the current or adjusted price as applicable and the new price for the purchase adjustments. Next, a human operator reviews the requested change, the impact of the requested change, and any required hard copy documentation needed to justify the change. The operator/business analyst either approves or rejects the change. Rejected transactions may be modified and resubmitted. Approved adjustment transaction values are applied to the database and an audit trail history is maintained. If the result of the change request has an accounting impact, the ACP logic 122 also generates the appropriate transactions to trigger the accounting processor 146.

The ACP logic 122 also includes loan conversion request processing logic for handling loan conversion requests. Thus, when a loan conversion request is received, this logic tracks the request for the change, determines the allowability of the change based on business rules, and employs the remainder of the ACP logic 122 to make the change.

The securities aggregation and management (SAM) logic 130 receives the loan level cash flow information produced by the LPC logic 100 and aggregates this cash flow information to produce security level information. The security level information is produced at each of the following levels: remittance/express date level within each piece/single pool; single pool level or piece level within each major pool; pseudo pool (pool-like reporting group) level; major header level for each major pool; choice pool level; strip level; mega pool level; and mega in mega (MIM) pool level. In addition to securities, the SAM logic 130 is also capable of processing and managing any grouping of loans, cash flows from loans, and other financial instruments. Using a packet activity processor 132, the SAM logic 130 determines the loans in a given pool, aggregates cash flows based on the pool and loan level attributes for all the loans and then updates the system database. The packet activity processor 132 has the flexibility to aggregate loan level cash flows at the most granular level to security level enabling the SAM logic to also manage specific cash flow strips (e.g., access yield strips, interest only strips). At the end of appropriate processing periods, the SAM logic 130 finalizes the relevant security information. The SAM logic 130 then uses a packet disclosure processor 134 to make final remittance level principal and interest, guaranty fee, and other draft amounts available to a cash processing logic 144 and to make security accounting data available to a book and tax accounting logic 146. The SAM logic 130 also calculates, at the various MBS security levels, disclosure data for investors and the payment distribution to investors. The SAM logic 130 also includes packet modification request processing logic which is used to modify packets in generally the same manner that the attributes of loans are modified as described above in connection with the ACP logic 122. The operation of the SAM logic 130, and in particular packets and the packet activity processor 132, is described in greater detail in connection with the packeting logic 154.

Further, the SAM logic 130 can be used to facilitate the provision of real-time data updating. For example, investors may be supplied with real-time analytic data. The analytic data may include any data that allows investors to more accurately determine the value of their holdings, such as data concerning monthly loan payments, loan prepayments, loan pay-offs, and so on. For example, when a loan pays off, investors may be provided immediate access to this information rather than waiting until the next MBS reporting cycle.

In the illustrated embodiment, the servicer and investor reporting logic 30 and the securitization logic 32 utilize the same data base (see FIG. 4). As a result, the data used by the securitization logic 32 is always synchronized with the data used by the servicer and investor reporting logic 30. Thus, it is not necessary for the securitization logic 32 to wait until the end of a periodic (e.g., monthly) reporting cycle to receive updated data, but rather the securitization logic 32 always has access to up-to-date loan information. In another embodiment, the servicer and investor reporting logic 30 and the securitization logic 32 may utilize different data bases that are synchronized on a weekly basis, on a daily basis, on a sub-daily basis, or in real time, depending on the frequency of update that is desired.

A servicing transfer logic 142 facilitates the process of transferring loans for the servicing rights of owned or securitized mortgages from one servicer to another or from one portfolio to another within the same servicer as of an effective date. A servicing transfer may be initiated, for example, if a servicer decides to stop servicing loans for business reasons, if a servicer decides to transfer a certain group of loans to another branch or portfolio, if a servicer is involved in a merger or acquisition of the servicer necessitating a transfer to the surviving entity, or for other reasons. The servicing logic 142 processes information regarding the old and new servicers and the loans that are subject to the change in servicing and updates loan record data for the respective affected loans. The effective date of the change in servicing is also specified. Information that is provided to the servicing transfer logic 142 as part of a servicing request includes the transferors servicer number, address and contact information, the transferees servicer number, address and contact information, unique loan numbers to be transferred, effective date, and other data. Additional steps, such as notifying the transferor of the termination and assessing transfer fees may also be performed.

The cash processor 144 provides a facility to allow servicers and other vendors to create and maintain bank account information. The accounts are bank accounts established with the purchaser to facilitate loan transactions. Servicers have the ability to create/select/update their account information in real time, including account numbers and remittance/disbursement information. The information captured in this process allows the cash processor 144 to create and execute Automated Clearing House (ACH) transactions. Historical records of servicers and vendors account and draft information is maintained to assist in resolving any issues that may arise.

Additionally, the cash processor 144 retrieves remittance and disbursement information from other areas of the data processing system 12. The remittance and disbursement information includes effective date, loan number, dollar amount, remittance code, and granular level details. The cash processor 144 performs a rollup of loan level details by servicer number as required. The cash processor 144 also performs a rollup of loan level details by seller number whenever the seller is not the designated servicer. The cash processor 144 triggers appropriate accounting transaction codes as needed that allow the book and tax accounting processor 146 to record applicable accounting entries.

Finally, the cash processor 144 creates cash transactions, for example, automated clearing house (ACH) transactions, outgoing check transactions, and so on. The cash processor 140 begins this process after the cash processor 144 has completed the process of assessing and validating remittance and disbursement data. The first step in creating a cash transaction is validating servicer/vendor bank account information. Ultimately, an ACH transaction is created that debits or credits the appropriate custodial bank account.

The book and tax accounting logic 146 manages accounting activities associated with the loans. The accounting logic 146 provides a consistent methodology for the recording of accounting events related to mortgage business activities across the acquisition logic 28 and the servicer and investor reporting logic 30 into subsidiary ledgers for posting to a general ledger. The book and tax accounting logic 146 supports the accounting activities related to the packaging of loan cash flows to the first level packet for the securitization logic 32. In addition, the book and tax accounting logic 146 supports the accounting activities related to forming securities or packets out of portfolio loan collateral. The investment accounting for securities held in portfolio and for the payment distribution on mortgage derivatives could also be handled by the book and tax accounting logic 146 or, preferably, is handled by separate accounting logic 156, described in greater detail below.

The book and tax accounting logic 146 journalizes mortgage related business activity, maintains subsidiary ledgers, provides audit trails, provides data integrity and control within the subsidiary ledgers, facilitates timely reconciliations, provides flexibility to account for new products or changes depending on actual accounting methodologies, and provides information needed to perform financial analysis. In one embodiment, the book and tax accounting logic 146 utilizes an accounting matrix which is a two-dimensional structure comprised of accounting “f amilies” and “f amily members.” The families are groups of accounting relevant transaction and loan attributes, and the family members are the allowable values for each of the groups. All intersections of families and family members have a debit and credit account number associated with each of the intersections. When the journal entry is created, the appropriate debit and credit account numbers are first assigned to each of the transactions as they are processed. The accounting matrix uses business rules processor 180 to automatically interpret the transactions. As new products are introduced, the accounting matrix is modified to incorporate new family and/or family members to properly record the new business activity. Similarly, as products become obsolete, or as the requirement for breaking out activity on the corporate general ledger becomes less detailed, the accounting matrix can be modified to adapt to those changes as well.

As business activities are processed, they are recorded/journalized in a subsidiary ledger according to the debit and credit account numbers assigned from the accounting matrix. This occurs by translating business activities into family and family member transactions that can be interpreted by the matrix. A subsidiary ledger provides the capability to view the lowest level of business activity that created the entry in the subsidiary ledger to maintain an audit trail for the subsidiary ledger activity.

As activity is recorded, a system walk forward test of the subsidiary ledger balances is also performed to assure data integrity with the subsidiary ledger. At the end of accounting cycles, activity within the subsidiary ledgers is automatically summarized and posted to the general ledger. Also, as activity is recorded, the system maintains the integrity of accounting data such that transaction data always matches sub-ledger balances wherever such data is viewed or reported. For example, a balance for the current accounting period for a given general ledger account number, for a given loan, equals the balance at the beginning of the current period plus the net activity for the current period for that loan and account number, as supported by the individual accounting transaction records.

In addition, the system maintains traceability of loan activity processed and recorded by all system functions and accounting data. For instance, any payments made to a loan recorded by LPC 100 in loan data is associated with the corresponding accounting transactions by means of a unique “busin ess activity ID.”

The system ensures data accuracy and completeness by validating the transaction balances stored by the streams equal to the accounting balances in the system for a particular accounting period. Periodically (e.g., at least once a month, week, year, quarter, etc.), at the end of the accounting cycle, activity within the subsidiary ledgers is summarized and posted to the general ledger through an automated interface with the general ledger system.

At the end of the accounting cycle, reconciliation is performed between the subsidiary ledger activity and balances, and the general ledger activity and balances using an automated reconciliation tool. An automated reconciliation tool may be provided that generates the results of the reconciliation and, through a user interface, displays the results to an operator. Any reconciling items between the subsidiary and general ledgers may be analyzed and resolved by the operator. Through the operator interface, the operator updates the status of the reconciling items to indicate the results of the analysis. As reconciling items are resolved, the operator triggers the automated reconciliation facility to repeat the reconciliation and display the results.

The book and tax accounting logic 146 also provides information for financial and operational analysis. Information related to the status of the book and tax accounting logic is provided to operations through an accounting console. The accounting console is a management and operational workflow tool that includes notifications and status information related to the book and tax accounting processes. It also provides summarized reports and the ability to view the detailed information supporting those reports.

A preferred implementation of the securitization logic 32 and subcomponents thereof will now be described. The securitization logic 32 includes sifting/sorting logic 152 which accesses inventory, identifies collateral or asset attributes and sub-attributes, and categorizes data at its most granular level in both aggregating and segregating cash flows associated with mortgage assets. The sifting/sorting logic 152 provides a user interactive application that allows users to define selection criteria (loan and/or atomic characteristics), prioritize them, evaluate results, and make decisions about market transactions and their related economics. By sifting and sorting through available inventories, cash flows may be qualified and quantified for optimal aggregation of targeted transactions, given relative market value. The sifting/sorting logic 152 operates under a user maintainable library of business rules associated with mortgage instruments and respective cash flows. An auto sift function is also provided to allow to batch processing of predefined inventory types. For example, a daily auto sift may be executed against “available for sale” loans to aggregate and pre-packet the loans for future transactions.

The purpose of the sifting/sorting logic 152 is to provide a mechanism by which users can examine the entire collateral universe and pair down to smaller groupings of collateral or assets within the universe. Collateral refers to any cash flow derived from loans, pools, securities, commitments, and packets. The purpose of sorting is to group the subset of collateral identified in the sifting process and organize it by a single or multiple attributes to further refine the pool of candidate collateral to be placed into a potential packet. The sifting/sorting logic 152 supports the packeting logic 154, described below.

The packeting logic 154 is used to create, maintain, and otherwise support packets. A packet is an aggregation or packaging of cash flows that is treated as an entity separate and distinct from the incoming cash flows that support the packet and from the cash flows that result from the packet. Packets maintain the data integrity of the underlying assets as received by the LPC logic 102 and create an information chain that maps to a higher-order asset (e.g., an MBS or other financial instrument to be sold to an investor). The source data for packets may be loan-level or packet-level information, and the packets themselves may represent actual securities or just a unit of reporting and remittance.

Packets permit the data processing system 12 to enable and support new transactions by providing a platform for sourcing, normalizing, and centralizing cash flow-related data and building the linkages between loan assets and securities or non-securitized assets. Packets provide greater flexibility in the transformation of cash flows from the primary mortgage/loan level to the secondary market and within the secondary market. Packets provide the flexibility not only to create and sell securities to investors but also to support non-securitized forms of packaging to enable selling or retaining cash flows from individual loans. The ability to create and manipulate packets enables the creation of new types of financial instruments and new types of transactions within the secondary market.

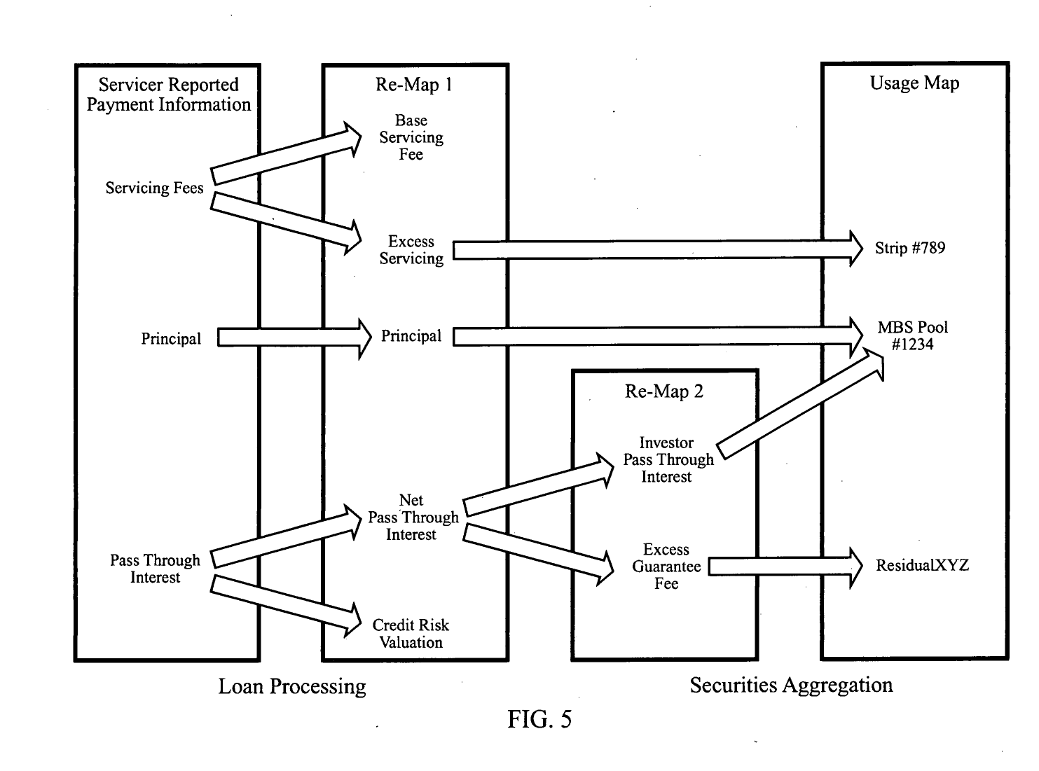

FIG. 5 depicts a sample data map from a lender reported inbound record, through re-map, to packets. In the example of FIG. 5, a loan acquired on a cash basis has a portion of its cash flows re-mapped, and some of those cash flows participate in two packets, one an out-of-Portfolio MBS pool, the other an excess servicing fee strip. In this arrangement, the incoming data and cash flows is decoupled from the outgoing data and cash flows. This separation allows the timing and collection of cash flows from servicers to be treated independently from timing of payments to investors. This is useful in the case of structured transactions.

Packets preferably store the following four categories of data: packet header information (creation, purpose, and transaction information); cash flow and disclosure uses (data map); periodic process instructions and information; output requirements information. Thus, a packet stores information about its own attributes, the disposition of its cash flows, and any reported output, including disclosure data. Additionally, a packet stores information that describes its behavior, which may be derived from external business rules. These business rules may be standard (as in the case of MBS packets), or they may apply to a specific packet (as in the case of a structured transaction). Packet data fields may be added or changed to support new products.

In some cases, it may be necessary to apply data decomposition (or “intern al re-mapping”) to lender reported data. Some of the data decomposition steps may precede packet creation and rollup, converting loan level data reported by lenders into a form useful to downstream processes. In cases where the internal use of lender reported inbound data is differs from its use within a packet, data re-mapping is also required for roll-up.

The accounting logic 156 supports additional accounting functions for the securitization logic 32 that are not already supported by the book and tax accounting processor 146. In general, the book and tax accounting processor 146 is responsible for performing maintenance accounting at the loan level (i.e., posting transactions), while the accounting logic 156 is responsible for the accounting logic associated with transformative accounting events. Transformative accounting events include, for example, securitization events (in which a loan is to be construed to be sold). Other transformative events include a securitization event in which only a portion of the cash flows are sold, a sale event of a portfolio securities, and a sale event involving a whole loan. In addition, the accounting logic 156 is responsible for ongoing maintenance in connection with the reconciliation of securities cash payables. The accounting logic 156 performs such things as deriving the initial cost basis at the time of acquisition for every loan and inventory, maintaining the cost basis of each loan, tracking accounting intent for each loan, and performing market valuation for each loan. Of course, although the functionality of blocks 146 and 156 are shown as being conceptually separate, this functionality could also be combined.

The position monitor 158 allows monitoring of the purchaser's overall trade and investment position. Particularly, the position monitor 158 is an interactive tool that is usable to monitor positions of investors of whole loans and securities, and designate or redesignate inventory between trading accounts. The position monitor 158 is able to provide this information in near real time because the position monitor 158 either uses the same transactional database(s) as the servicer and investor reporting logic 30 and the securitization logic 132 or, preferably, uses a separate data base that is synchronized with these data bases. For both whole loans and securities, the position monitor 158 provides daily and month-to-date commitment/trade and delivery/settlement positions. The position monitor 158 also provides cumulative inventory positions held by the portfolio. The position monitor 158 allows investors to manage inventory from an economic, risk management, and regulatory accounting and taxation perspective. It also allows investors to determine or designate what assets to buy, what assets to sell, and what assets to retain or hold for investment. The portfolio manager 158 provides investors with a clear and concise view of their current net position of inventory.

The out of portfolio (OOP) pooling logic 160 permits the data processing system 12 to be used for pooling loans to create financial instruments in situations where the loans are owned by the entity that owns or operates the data processing system 12 or by an entity other than the entity that owns/operates the data processing system 12. The OOP pooling logic 160 provides the owner of the loans being pooled with the ability to select asset attributes and sub-attributes at a granular level, the ability to select loans to optimize chartered pool statistics, the ability to flexibly map incoming and outgoing cash flows, and the ability to use an on-screen display to manipulate collateral. The out of portfolio pooling processor 160 also has the ability to collateralize asset cash flows as described above in connection with the packeting logic 154.

The whole loan trading logic 162 provides a facility for engaging in whole loan trades to permit the owner or operator of the data processing system 12 to identify and sell loans out of its portfolio to other entities. The whole loan trading logic 162 also provides logic for reporting to the servicer of a sold loan (1) that the loan has been sold and (2) the identity of the new owner of the loan, allowing the servicer to begin reporting payment information to the new owner.

Referring to FIG. 4, the common services logic 34 includes work flow processor 170 which generates notifications about required actions and routes the notifications to users of the data processing system 12 according to pre-defined processing sequences for request approvals and exception report resolutions. The work flow processor 170 also keeps track of status and actions related to work items.

The report processor 172 generates reports based on users' requests. The report processor 172 allows data to be extracted from the data bases to prepare reports that can be sent out through the user services logic 22. The reports that are returned may be bulk transfers of data. The report processor 172 supports generating the reports described above in connection with the acquisition logic 28, the servicer and investor reporting logic 30, and the securitization logic 32.

The database and access control logic 174 provides database and user security administration and control for the databases in the data storage system 38 and functions available through system 12. The database access and control logic also maintains referential integrity, processes queries and updates, and performs all tasks related to access and control of the databases in the data storage system 38.

The process controller/scheduler 176 triggers execution of processes based on time schedule and/or events received from application components. The process controller/scheduler encapsulates information on processing interdependencies between different components in the data processing system 12.

The audit logging logic 178 logs data that is needed for historical tracking of the activities of the data processing system 12. The purpose of the data logging is primarily to meet audit requirements in connection with the transactions processed by the data processing system 12.

The business rules processor 180 is a rules engine that encapsulates business rules to permit the business rules to be applied to the loan data. Examples of the business rules applied by the rules processor 180 have been described throughout the discussion of the data processing system 12. A user interface is provided that allows the business rules to be modified and that allows new business rules to be added or obsolete business rules to be deleted. The rules processor 180 maintains the business rules separate from the remainder of the application code that implements other aspects of the data processing system 12. This allows the business rules to be modified/added/deleted without requiring revisions to the application code. The ability to modify or add business rules quickly facilitates the introduction of new types of loan products and investment instruments, because the data processing system 12 may be easily modified to implement any special data processing required for the implementation of the new loan products/investment instruments. Preferably, the rules processor 180 is provided as three separate rules processor, one for each of the acquisition logic 28, the servicer and investor reporting logic 30, and the securitization logic 32, with separate user interfaces for each rules processor.

As previously indicated, service granularity is achieved in part by representing loans as a series of data attributes. The following is an example of a set of attributes that may be used to characterize loans: accounting class code; accounting close effective period; accounting reporting category code; actual UPB at acquisition; adjusted last paid installment date; adjusted unpaid principal balance; ceiling; change frequency; change method; conduit code; custodian code; downward cap; downward cap code; effective date; excess yield; excess yield adjustment; extended term; purchaser loan number; final step change; first PITI (principal, interest, taxes, insurance) due date; fixed interest rate; fixed pass-thru rate; fixed payment amount; floor; frequency of payment change; frequency of rate change; future feature code; index code; index lookback; interest rate; loan guaranty payment date; loan conversion date; loan guaranty date; loan payoff interest calculation code; loan rate effective date; loan to value ratio; LP control record; lender pass through (LPT) type code; maximum term; months payment control effective; months rate control effective; mortgage margin; mortgage term; net interest adjustment; new payment amount; next control record; next scheduled payment change date; next scheduled rate change date; number of months in effect; other fees collected adjustment; pass-thru rate; payment change amount/percentage; payment change method code; payment control record; payment type code; principal adjustment; processing status code; product code; rate change method code; rate change percent; rate control record; rate conversion status code; rate rounding method; rate type code; reclassification date; remittance day code; required change index; required margin; secured unpaid principal balance; servicing fee; servicing fee adjustment; servicing fee type; servicing remittance option; unpaid principal balance; upward cap; upward cap code. In addition to the above-mentioned attributes, additional attributes may be used in connection with particular types of specialty loan products.

As previously indicated, data granularity is achieved at least in part by decomposing loan assets into a series of cash flows. A cash flow may be any type of payment, whether of principal, interest, or fees. Cash flow may also includes credit-related losses, which manifest themselves from the securities standpoint as negative investor payments (i.e., a reduction to positive cash flows). Possible sources of cash flow may be associated with principal, interest, servicing fees, guarantee fees, mortgage insurance, prepayment penalties, borrower-paid fees, servicer advances, servicer recoveries, loss/default components, and REO activity. For principal, individual cash flows that may be identified include the following: scheduled principal (amount payable based on scheduled amortization), actual principal (what was applied as principal), unscheduled principal (amount from borrower applied in excess of scheduled), advanced (amount not collected from borrower but remitted to investor), shortfall (underpayment from borrower, usually meaning less than full scheduled amount). For interest, individual cash flows that may be identified include the following: scheduled Interest (amount payable), actual (what was applied), excess (interest collection in excess of amount payable), advanced (not collected from borrower but sent to investor), shortfall (underpayment from servicer), capitalized (negative amortization), other capitalized interest (delinquency), unrecoverable prepayment interest shortfall. For servicing fees, individual cash flows that may be identified include the following: gross servicing fee, core servicing fee (usually relates to tax), excess servicing fee, safe harbor (tax). For guarantee fees, individual cash flows that may be identified include the following cash flows: gross guarantee fee (GF) (total charged to the lender), cash flows for internally tracking costs (e.g., costs associated with credit risk), base GF, GF variance , and other GF adjustments. For mortgage insurance (MI), individual cash flows that may be identified include the following: lender paid MI, borrower paid MI, portion of GF construed to be MI, back-end MI. For prepayment penalties, individual cash flows that may be identified include the following: prepayment penalty, prepayment penalty (borrower-paid), yield maintenance fee (borrower-paid). For borrower-paid fees, individual cash flows that may be identified include the following: borrower-paid fees, late payment fee, conversion/modification fee. For seller advances, individual cash flows that may be identified include the following: advanced principal, advanced interest, advanced guaranty fee, servicing advances (usually relates to defaults, e.g., T&I). For servicer recoveries, individual cash flows that may be identified include the following: recovered principal advances, recovered interest advances, recovered guaranty fee advances, recovered servicing advances. For default activity, cash flows that may be identified include the following: net realized loss (total amount payable to investors less all recoveries), foreclosure expenses, attorney fees, recoup of non-recoverable advances, loss due to modification, loss due to appraisal reduction, loss due to deficiency valuation, non-capitalized deferred interest (e.g. workout), interest paid on advances. For REO activity, cash flows that may be identified include the following: foreclosure sale proceeds, rental income, insurance proceeds, tax expenses on REO, repair expenses on REO, sale/marketing expenses on REO, REO property maintenance expenses. It may be noted that some of the above cash flows are aggregate cash flows that can be further decomposed. Other cash flow pertinent information that may be tracked includes unpaid principal balance (UPB) (including scheduled UPB and actual UPB), participation percentage (including principal participation percentage, interest participation percentage, and servicing fee participation (basis points)), discount rate (used to calculate yield maintenance or prepayment penalty), appraised balance, foreclosure sale date, and REO sale date.

As previously indicated, service granularity is achieved in part by representing loans as a series of attributes. The following description provides more detail regarding the definition, processing, development and pricing of attribute-based loan products.

In the preferred embodiment, loans are defined in the data processing system 12 using a series of sub-loan level attributes rather than using product-level product codes. Thus, in the data processing system 12, data processing occurs with respect to a particular combination of attributes and/or a particular combination of values for those attributes. Product names or other product-level designations are not meaningful apart from serving as a convenient shorthand reference for a human user to refer to the particular combination of attributes/attribute values that define the mortgage product in the data processing system 12.

Depending on the particular attribute, attributes may have only two different possible values (e.g., presence or absence of a particular feature, or presence or absence of a particular attribute representing presence or absence of a particular feature), a limited number of different and generally mutually exclusive possible values (e.g., new home loan, refinance, cash out refinance), or an infinite or near infinite number of different possible values (e.g., as in the case of attributes that may be any value within a range, such as a loan to value ratio). The following is an example of a set of attributes that may be used to characterize loans according to such a configuration: accounting class code; accounting close effective period; accounting reporting category code; actual UPB at acquisition; adjusted last paid installment date; adjusted unpaid principal balance; ceiling; change frequency; change method; conduit code; custodian code; downward cap; downward cap code; effective date; excess yield; excess yield adjustment; extended term; purchaser loan number; final step change; first PITI (principal, interest, taxes, insurance) due date; fixed interest rate; fixed pass-thru rate; fixed payment amount; floor; frequency of payment change; frequency of rate change; future feature code; index code; index lookback; interest rate; loan guaranty payment date; loan conversion date; loan guaranty date; loan payoff interest calculation code; loan rate effective date; loan to value ratio; LP control record; LPT type code; maximum term; months payment control effective; months rate control effective; mortgage margin; mortgage term; net interest adjustment; new payment amount; next control record; next scheduled payment change date; next scheduled rate change date; number of months in effect; other fees collected adjustment; pass-thru rate; payment change amount/percentage; payment change method code; payment control record; payment type code; principal adjustment; processing status code; product code; rate change method code; rate change percent; rate control record; rate conversion status code; rate rounding method; rate type code; reclassification date; remittance day code; required change index; required margin; secured unpaid principal balance; servicing fee; servicing fee adjustment; servicing fee type; servicing remittance option; unpaid principal balance; upward cap; upward cap code. In addition to the above-mentioned attributes, additional attributes may be used in connection with particular types of specialty loan products. In the most preferred embodiment, each different product variation/feature that the purchaser supports is supported using attributes.

The data processing system 12 is configured to process data in connection with various different types of loans having different attributes and, to this end, the following arrangement is preferably used. First, the data processing system 12 is configured to be capable of processing data in connection with a default set of attributes associated with a common or “standar d” mortgage product. Typically, the default attributes associated with the standard mortgage product will also be present in most other loans that are processed by the data processing system 12. For example, most loans will have attributes that specify the term of the loan, the interest rate of the loan, whether the loan is for an owner-occupied property or an investment property, whether the loan is for a single family or multi-unit property, and so on. As an example, the default attributes may include some or all of those attributes listed in the previous paragraph.

Second, the data processing system 10 includes various sets of business rules which are developed around the default attributes and which are usable to process data in connection with the standard mortgage product. For example, a set of business rules is provided in connection with the pricing logic 86 that is configured to examine various attributes and generate a price for a loan based on the values of those attributes. Likewise, a set of business rules is provided in connection with the delivery logic 88 that is configured to analyze loan attributes, the associated deal/contract with a seller, and execution parameters to determine if the loan is acceptable for submission under the terms and conditions of a particular deal with the seller. Likewise, a set of business rules is provided in connection with the loan process and compare logic 100 that is configured to process payment data based on the values of various attributes. Other sets of business rules are provided for other operations as previously described herein. Each business rule is configured to be either applied or not applied, depending on the attributes of a particular mortgage product. During loan processing, therefore, determinations are made as to which business rules should be applied based on which attributes are present in the mortgage product under consideration.

The data processing system 12 also utilizes a flexible data acquisition mechanism implemented using a configurable data stream. The configurable data stream has a plurality of fields of data corresponding to the default attributes and containing values for each of the default attributes. When data is received in connection with a particular loan at delivery, each field is tagged with a label that indicates the correspondence between the field and one of the default attributes. The data stream may then also contain one or more additional non-standard fields corresponding to attributes which are not included in the set of default attributes. The non-standard fields contain both attribute-specific instructions and information for processing the loan data as well as the value of the attribute itself. By way of example, the configurable data stream may be implemented using the extensible mark-up language (XML).

According to this arrangement, in order to add a new attribute, it is not necessary to reconfigure the entire data processing system 12. Rather, the additional attribute is added by modifying the configurable data stream to include the new attribute. New business rules may also be added to the rules processor 180 as needed for the additional attributes. Such business rules may be configured to override the business rules associated with the default attributes in situations where the non-standard attributes require processing that is different from the processing that is performed in connection with the default attributes. Thus, when the data processing system 12 identifies a data field for a non-standard attribute in a data stream, the data processing system 12 examines the data field for processing instructions and identifies and applies any business rules that are pertinent to the non-standard attribute.

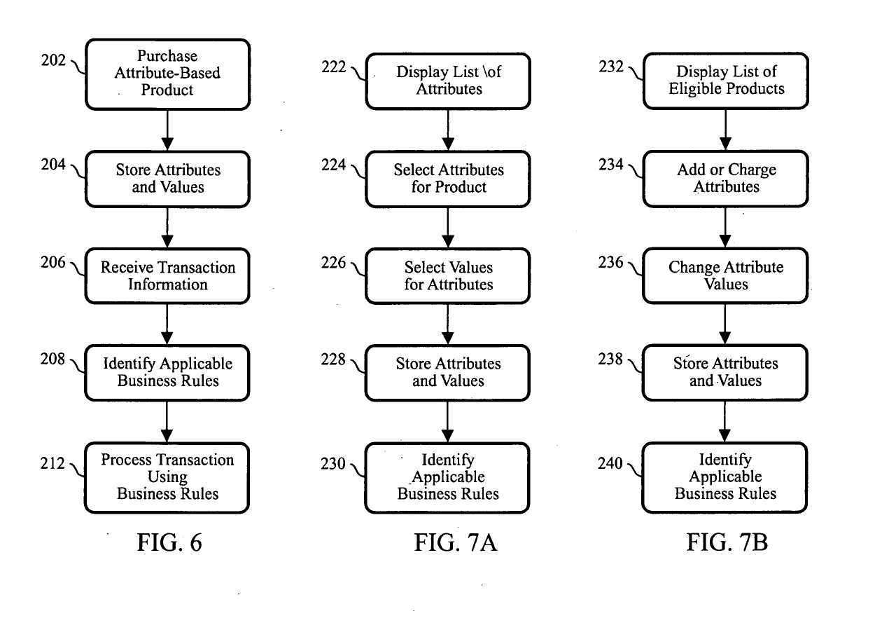

Referring now to FIG. 6, FIG. 6 is a flow diagram of a process for purchasing and processing an attribute-based mortgage product. As shown in FIG. 6, the purchaser purchases the mortgage product from the seller (step 202). The mortgage product may for example be purchased as part of a group of loans sold by a seller.

After making the purchase, the data processing system 12 stores information relating to the purchased attribute-based product (step 204). The information relating to the mortgage product includes information identifying each of the attributes in the mortgage product and the values of those attributes.

Once the information relating to the purchased attribute-based product is stored, such as in a database, the mortgage product can be processed in accordance with any transactions relating to the product. To perform this processing, the data processing system 12 receives transaction information applicable to the mortgage product (step 206). The transaction information includes, for example, payments, rate changes, curtailments, and so on. The transaction information may be received and processed by the servicer and investor reporting logic 30, as described above.

Whenever transaction information is received, the data processing system 12 identifies each business rule associated with the selected attributes (step 208) based on the presence or absence of particular attributes. Then, using the identified business rules, the data processing system 12 processes the transaction information for the purchased attribute-based product (step 210). This processing can include any of the loan processing described elsewhere herein.

This dramatically simplifies the process of expanding the capabilities of the data processing system 12 to process data associated with new types of loans. The capability to process a new type of loan may be added by adding an additional attribute to a list of available attributes corresponding to the new product feature (or modifying existing attributes), by using the attribute to indicate the presence or absence (and/or other characteristics about the new feature) in a particular loan, and by modifying the rules engine to incorporate additional rules regarding the new loan feature. It is not necessary to build a completely new data processing system for the new type of loan. This makes it easier to offer new types of loans which are more optimally configured to meet the needs of individual borrowers.

Referring now to FIG. 7A, FIG. 7A is a flow diagram of a process for creating an new attribute-based mortgage loan product. The process of FIG. 7A may be carried out by the data processing system 12 responsive to operator inputs from a product developer. The product developer may be an authorized employee of the purchaser or other operator of the data processing system 12. In this configuration, pricing information for the new mortgage product may be developed using financial engineering tools and entered into the pricing logic 86 under the supervision of one or more authorized employees. Alternatively, it would also be possible for the product developer to be an authorized employee associated with a lender or other seller of loans. This would allow for a mass customization configuration in which mortgage products may be created for individual borrowers by combining attributes in any manner desired by the borrower. This configuration would require more robust pricing logic 86 in as much as the pricing logic 86 would need to be able to automatically generate prices for a much wider array of attribute combinations. Herein, it will be assumed that the product developer is associated with the purchaser of the loans.

To simplify the process for generating a new attribute-based product, it is possible to start the process by using existing eligible loan products. The existing loan products already consist of a plurality of attributes and attribute values. In this process, as shown in FIG. 7A, a product developer first identifies the product from among a plurality of displayed lists of eligible products (step 222). For example, the system 12 can display a list of all seller favorite products from which the seller can select a product.

The selected eligible product includes a plurality of predetermined attributes and attribute values. Using these attributes and values as a starting point, the product developer can create a new attribute-based product from the selected eligible product. To do so, the product developer may add or change the attributes of the selected eligible product (step 224). The changes may include removing one or more of the original attributes, and the additions may include adding one or more attributes to the original attributes.

In addition to adding or changing attributes, the product developer may change any of the one or more values of the original attributes of the selected eligible product (step 226). For example, if the selected eligible product was a 30-year fixed rate mortgage, the product developer can change the term from 30 years to some other term, such as 27.

When selecting attributes, the available attributes and values may be limited based on previously selected attributes and values. This limitation may arise when attributes or values would create inconsistencies or impossibilities in the structure of the loan. The data processing system 12 can be configured to ensure that these inconsistencies are avoided by making sure the product developer is not able to select attributes or values that create such inconsistencies.

After the product developer has made the additions and/or changes to the attributes and values of the selected eligible product, the data processing system 12 stores information relating to the resulting attribute-based product (step 228). The information relating to the attribute-based product includes information identifying each of the attributes in the product and the values of those attributes. The information can also include processing instructions associated with the additional attribute and/or a name or title for the attribute-based product. Pricing information for the new mortgage product may also be stored. An exemplary process for generating a price for an attribute-based mortgage product is discussed below.

In addition to storing the information, the data processing system 12 identifies the applicable business rules corresponding to the attributes of the attribute-based product (step 230). As described above, the business rules enable the attribute-based product to be priced and processed by the data processing system 12.

Referring now to FIG. 7B, FIG. 7B is a flow diagram of another process for creating an attribute-based mortgage product. In the process of FIG. 7B, the mortgage product is created by selecting attributes rather than by modifying an existing mortgage product. As shown in FIG. 7B, the data processing system 12 presents the product developer with a list of possible attributes to include in the attribute-based product (step 232). The product developer then selects which attributes to include in the attribute-based product (step 234). In addition to selecting the attributes to include in the product, the product developer selects values for each of the selected attributes (step 236). The attribute-based product includes each of the attributes and values selected by the product developer. After the attributes and values have been selected, the data processing system 12 stores information relating to the attribute-based product (step 238). In addition to storing the information relating to the attribute-based product, the data processing system 12 identifies each business rule associated with the selected attributes (step 240).

To generate a price for any mortgage product, a base price for a standard mortgage product comprising default attributes is first generated with reference to the capital markets. For example, prices for cash loans may reflect the current MBS market. Yield adjustments are then made in connection with attributes that make a particular mortgage product different than the standard mortgage product. Any of a number of different attributes (such as the attributes provided above) can be used in attribute-based pricing or attribute-based adjustments to products. One example attribute is maturity date. For example, all other things being equal, a 20-year loan differs from a 30-year loan by a maturity date. Assuming a pricing relationship of 10 basis points because of the difference in maturity date, the 20-year loan can be priced based on the 30-year loan by adding 10 basis points to the purchase price. In a similar fashion, other attributes can be related to price in an established fashion and used in pricing adjustments for a base product.

Each product attribute represents a certain risk or payment opportunity, and this information can be used to generate a yield adjustment to the base price for any product attribute. Also, regardless of how many features a product comprises, the relationship of the features to underlying base products are known because constituent parts of the product are recognized. The greater granularity enabled by the data processing system 12 allows for mapping relationships of product features and attributable prices. Yield adjustments in connection with particular attributes are one example of yield adjustments that may be made; other adjustments include an interest rate adjustment, term adjustment, or any other product change necessitated by attribute changes and defined by established rules. By keeping a map of relationships and yield adjustments, price quotes can be made depending on selected features.

Prices and yield adjustments are generated the pricing logic 86 which further invokes the rules processor 180. The simplest case of determining a yield adjustment for an attribute is the case in which the yield adjustment for the attribute does not depend on the presence or absence of any other attributes. In this case, a single business rule may be provided that processes data in connection with the attribute and, under all conditions, computes a yield adjustment for the mortgage product depending on the value of the attribute.

In other cases, pricing interdependencies exist between attributes that may result in more sophisticated pricing rules. For example, a situation may exist in which product feature A, product feature B, and product feature C are each worth 10 basis points if such product features occur alone in a loan, but are not worth 30 basis points if all three product features occur in a loan. Accordingly, the rules logic 180 includes different business rules that are applied depending on the particular combination of attributes is present in a given mortgage product. That is, there may be one business rule for the situation in which product feature A is present, another business rule for the situation in which product feature B is present, another business rule for the situation in which product feature C is present, and additional business rules for the situations in which particular combinations of product features A-C are present. Therefore, depending on which product attributes are present, the correct business rule is identified and applied and the correct yield adjustment is determined for a loan having the particular combination of attributes in question. Thus, numerous rules may be established, having a wide variety of additive or exclusive relationships between one another.

As previously noted, yield adjustments are made based on the attributes that are present in a particular mortgage product. The yield adjustments take into account risks and payment opportunities and the amounts of the yield adjustments may be determined using analytic models. Preferably, multiple pricing options are available for each attribute. For example, analytic models may be used to assess the risk/payment opportunities associated with a particular attribute and generate a first yield adjustment, market data may be used to generate a second yield adjustment, and so on. The data processing system 12 then has the ability to pick and choose between different yield adjustments for the same attribute, depending on which yield adjustment offers a more favorable price. Thus, the use of attributes allows a high degree of pricing granularity to be achieved when purchasing loans.

In another embodiment, analytic models and techniques used to generate the yield adjustments may be updated based on the data processed by the data processing system 12. Thus, financial performance data regarding the loans in the data processing system 12 can be used to update (e.g., on a monthly, daily, sub-daily or real-time basis) the analytic models and techniques used to determine the yield adjustments for particular attributes. Additionally, other data feeds may be used to import market data on a monthly, daily, sub-daily or real-time basis if multiple yield adjustments (market and non-market) are determined for each attribute.

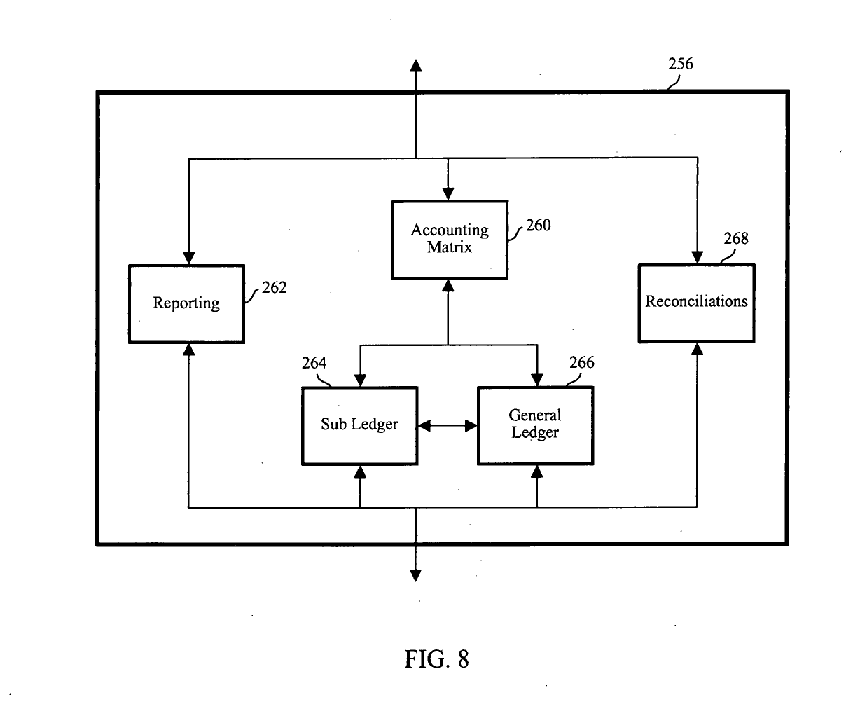

As previously described, servicer/investor reporting logic 30 comprises book and tax accounting logic 146. Book and tax accounting logic 146 is used to manage accounting activities associated with the loans processed using system 12. Also, book and tax accounting logic 146 may be combined with accounting logic 156. The combined logic may be used to manage accounting activities associated with both the loans and the securitization of the loans. The following description provides more detail regarding the processing, managing, entering, etc. of various transactions using book and tax accounting logic 146 and/or accounting logic 156. In the following description, book and tax accounting logic 146 and/or accounting logic 156 are referred to collectively as the accounting logic 256 (see FIG. 8).

Referring to FIG. 8, one embodiment of the accounting logic 256 is shown. The accounting logic 256 includes accounting matrix 260, reporting logic 262, reconciliation logic 268, sub-ledger 264, and general ledger 266. In other embodiments, various aspects of the accounting logic 256 may be modified to satisfy the particular needs of the purchaser (e.g., logic 146 may only include a single ledger or more than two ledgers, etc.).

The accounting matrix 260 is used to provide the appropriate journal entries for the various transactions that may be entered into data processing system 12. The accounting matrix 260 comprises “f amilies” and “family members” (the “f amilies” and “family members” m ay also be referred to herein as “attributes” and “attribute values,” respectively). The families are groups of accounting relevant transaction attributes (transaction attributes may include loan attributes when the transaction is mortgage related), and the family members are the allowable values for each of the groups.

In general, the accounting matrix 260 is a multidimensional approach to determining the accounting treatment of a transaction based on the attributes and attribute values of a particular transaction. Thus, the combination of the attributes and associated attribute values of a transaction determines the accounting treatment of the transaction and, in particular, which debit and credit accounts should be associated with the transaction.

A wide variety of transactions may be defined in terms of its attributes and attribute values. In one embodiment, the transactions are mortgage related transactions that are defined based, at least in part, on the attributes and attribute values of the mortgage loans. For example, such transactions may include transactions related to acquiring or purchasing mortgage loans, servicing a mortgage loan, and/or securitizing a mortgage loan. It should be appreciated that there are a wide variety of business activities that generate various transactions that may be accounted for by determining the attributes and attribute values of the transaction.

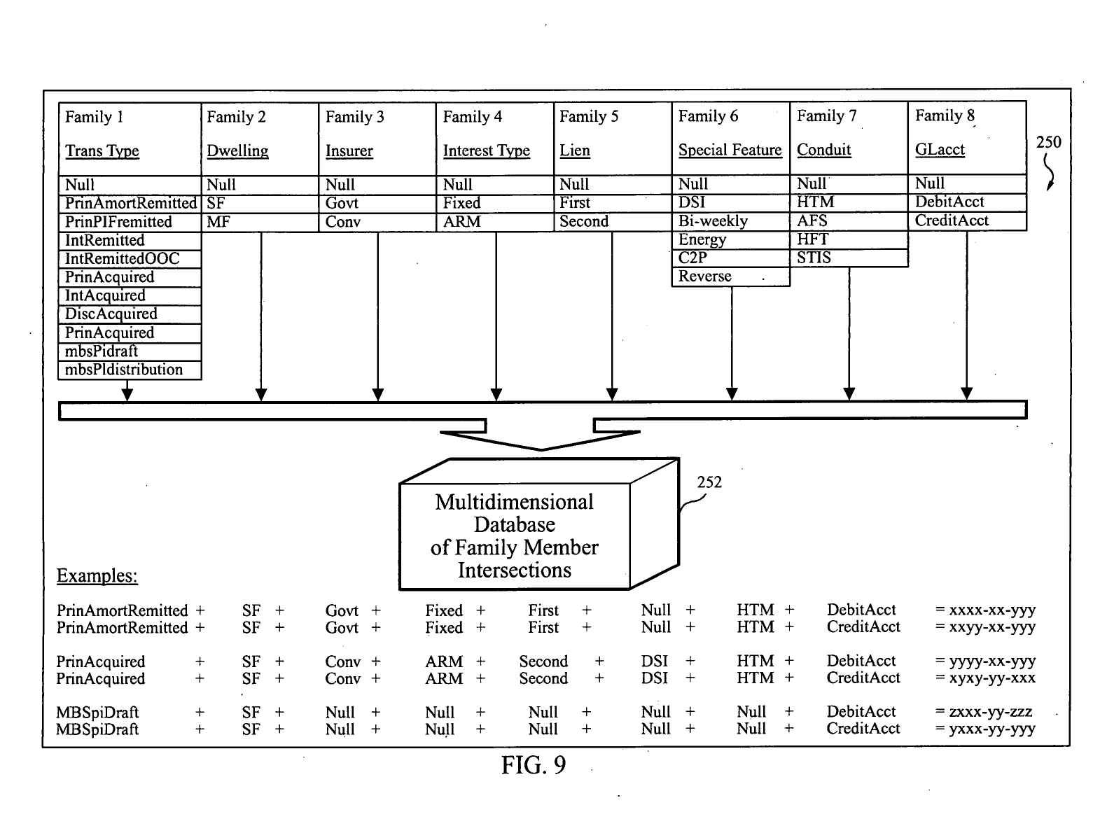

Referring to FIG. 9, accounting entries are generated by mapping the attributes of a particular transaction to the accounting matrix 260. The embodiment of the accounting matrix 260, shown in FIG. 9, includes eight families with each family comprising a variety of suitable family members. The families and family members are used as a basis for classifying transactions (e.g., mortgage-related transactions) to the appropriate credit and debit accounts on the general ledger. In one embodiment, every combination of families and family members is assigned debit and credit account numbers that may be entered on one or both of the sub-ledger 264 and general ledger 266. In a further embodiment, this may be accomplished by using one or more suspense or temporary account numbers. The suspense account numbers may be used as a default account number for those situations where a debit and/or credit account number has not been entered for a particular combination of families and family members. Accordingly, in most situations, the suspense account number is only used temporarily until the appropriate credit and/or debit account numbers are determined.

Exemplary families 1-8 comprising the selected family members are shown in table 250. In the embodiment shown, families 1-8 represent transaction type, dwelling, insurer, interest type, lien, special features, conduit (i.e., what the purchaser's intenti ons are: e.g., held for sale, held for investment, etc.), and general ledger account, respectively. For each of these families, there may be a variety of family members. For example, for the dwelling family, the family members include null, single family, multi-family, and so on. Thus, the family members represent values that may be used to characterize the dwelling. For the interest type family, the family members include null, fixed, ARM (Adjustable Rate Mortgage), and so on. Again, the family members represent values that may be used to characterize the interest type of the underlying loan. In table 250, all of the families include a family member value of null, which is the default if one of the other values is not specified. However, it should be understood that there may be families that do not include the value of null.

A wide variety of families and family members may be used in the accounting matrix 260. Typically, however, the selection of families and family members to include in the accounting matrix 260 is determined based on the accounting treatment that is desired by the purchaser for the various transactions handled by accounting logic 256. Accordingly, the families and family members are often selected based on the business activities which the purchaser is engaged in and the accounting treatment that is provided for those business activities.

Table 250 shown in FIG. 9 provides exemplary families and family members for accounting for mortgage related business activities (e.g., loan servicing, processing payments to investors in MBSs, etc.). However, the purchaser may also need to account for other transactions and business activities. In addition, there may be mortgage related business activities that are defined using attributes and attribute values that may not presently be in the accounting matrix 260. In order to provide greater flexibility in these situations, the accounting matrix 260 may be easily modified to include new attributes and/or attribute values.

Family 1 in table 250 (transaction type) represents the accounting activity translation corresponding to the business activity of the purchaser. The other families are used to further describe the transactions in order to categorize the activity on the sub-ledger 264 and/or general ledger 266. In one embodiment, all possible combinations, or intersections, of family members for the families are associated with debit and credit account numbers that relate directly to the account numbers in the purchaser's led ger(s).

In the embodiment shown in FIG. 9, accounting matrix 260 comprises a multidimensional database 252, which includes all or substantially all of the combinations of family members and the associated debit and credit accounts for the combinations. Database 252 may be accessible by the various logic systems and processors provided in system 12. For example, accounting matrix 260 may be accessed by any of the other processors and/or logic throughout system 12 (e.g., securitization logic 32, servicer and investor reporting logic 30, etc.). In other embodiments, database 252 may comprise debit and credit accounts for only a fraction of the combinations of family members in the accounting matrix 260 (e.g., database 252 only includes combinations of family members for frequently used combinations).

Referring to the bottom of FIG. 9, three examples are shown where the accounting matrix 260 is used to determine the accounting treatment of the transactions based on the values of the family members of the various families. The examples use families 1-8 as shown in table 250. In the first example, the transaction is identified as PrinAmortRemitted and the values for the following families are as follows: dwelling—single family, insurer—government, interest type—fixed, lien—first, special feature—null, conduit—htm, debit account—XXXX-XX-YYY, and credit account—XXYY-XX-YYY. Thus, when this particular combination of values is input into the accounting matrix 260, the appropriate debit and credit account numbers are output as shown. The second example is similar to the first in form but with different values for some of the family members. When this combination of values is input into the accounting matrix 260, debit and credit account numbers are output which are different than those from the first example. The third example is also similar to the other two examples in form except that the transaction type is related to a MBS. In the third example, all of the values of all of the families are null except for the dwelling family, which is specified to be single family. Based on this information, the accounting matrix 260 determines the appropriate debit and credit accounts to account for this transaction.

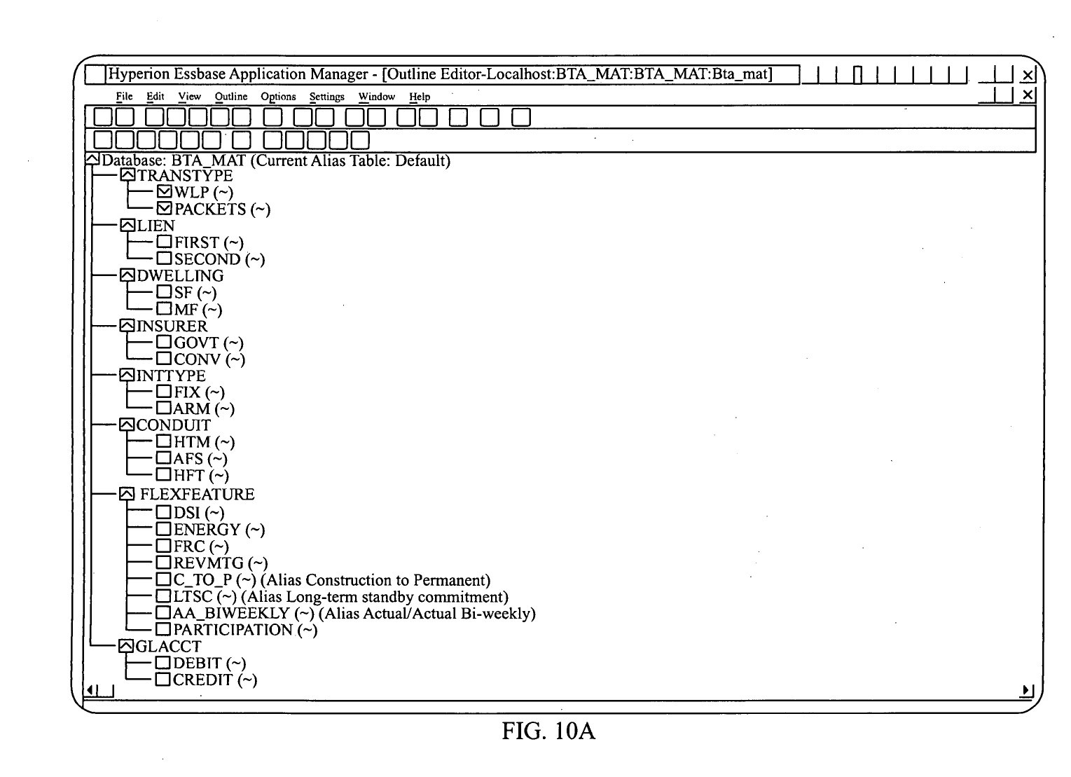

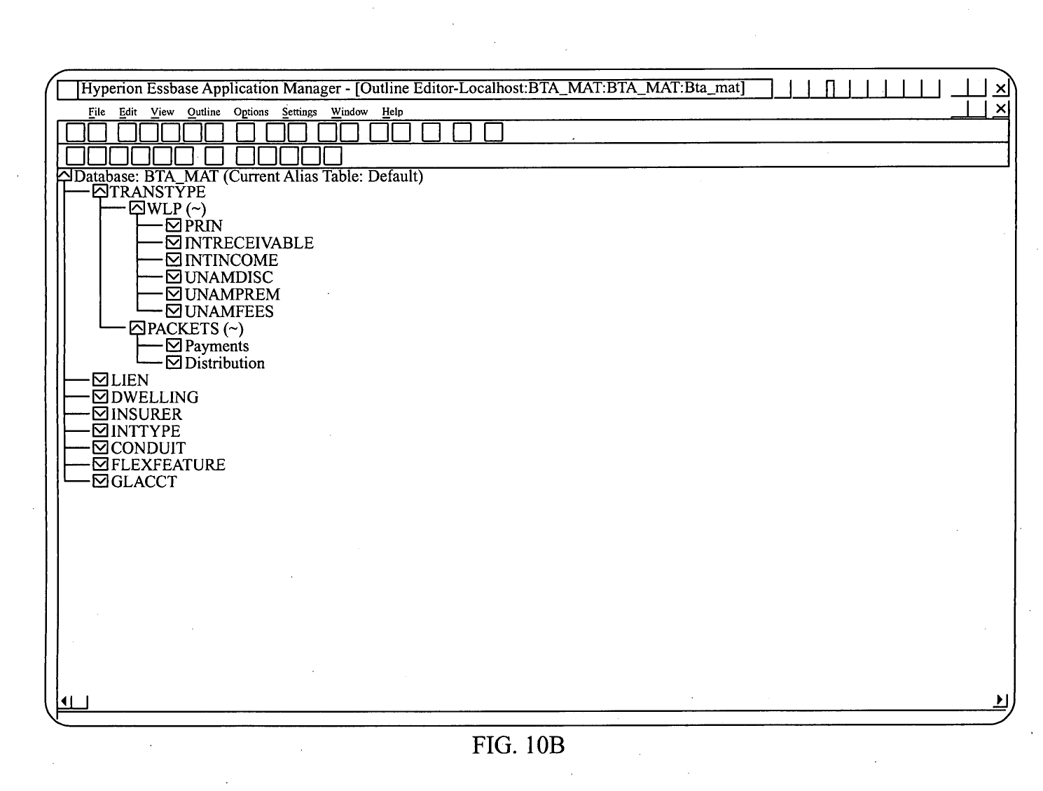

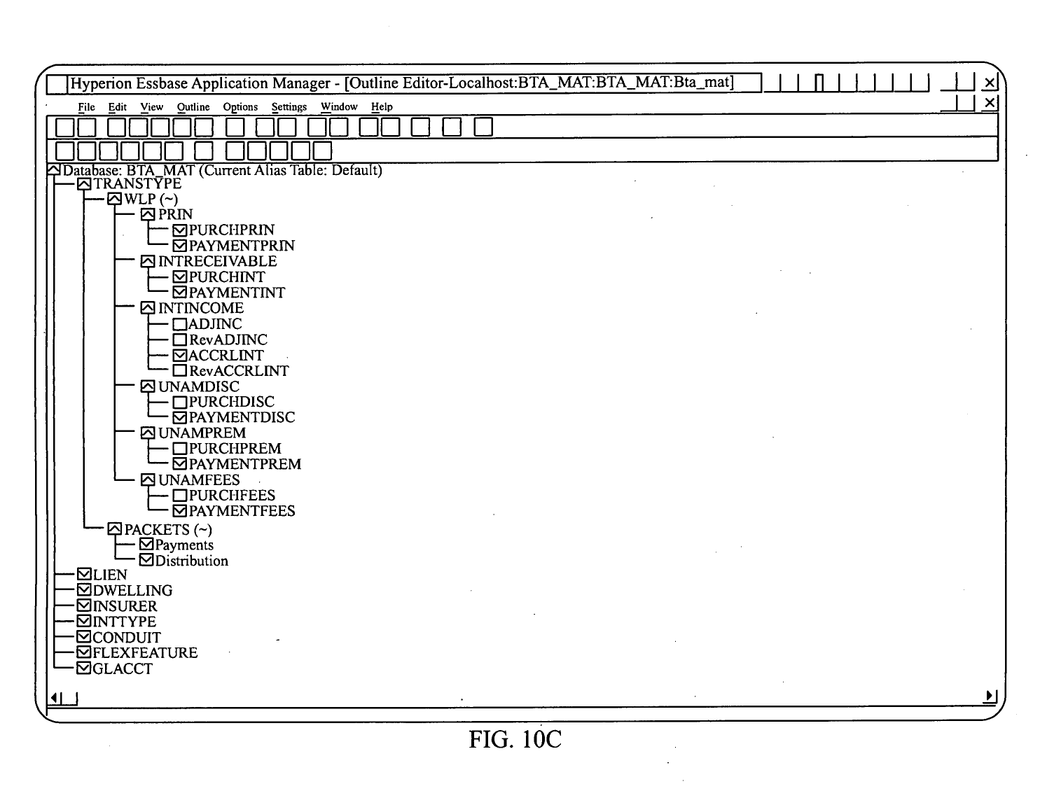

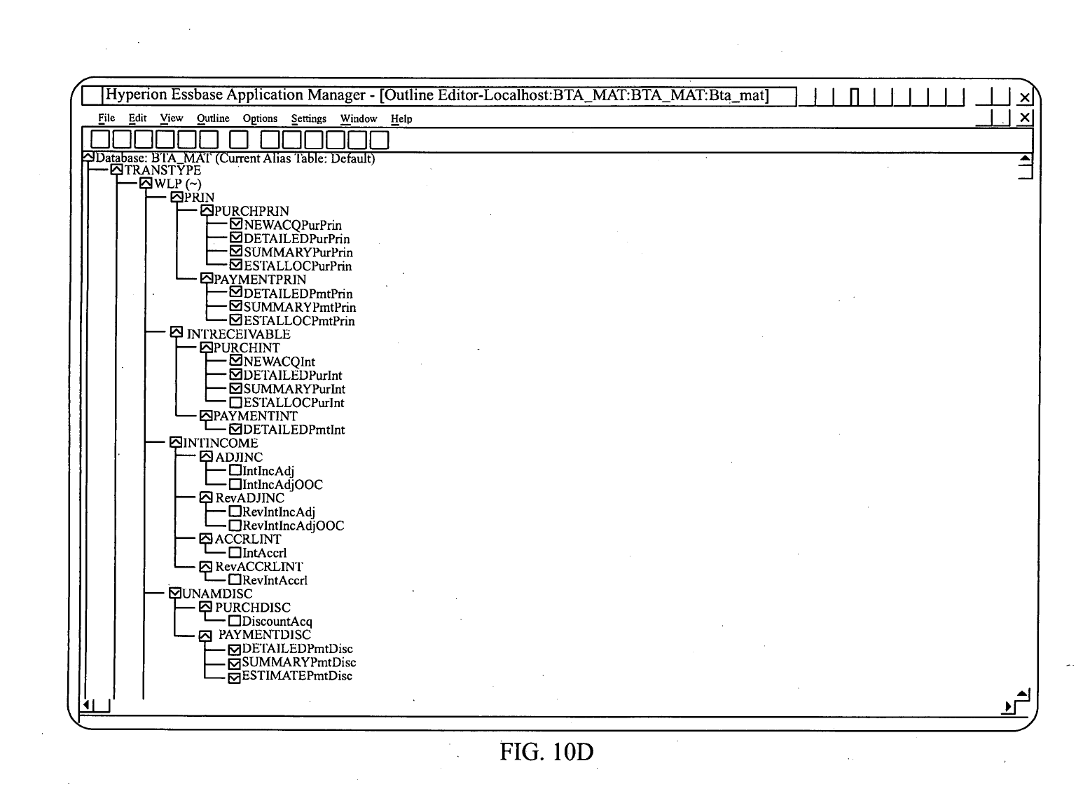

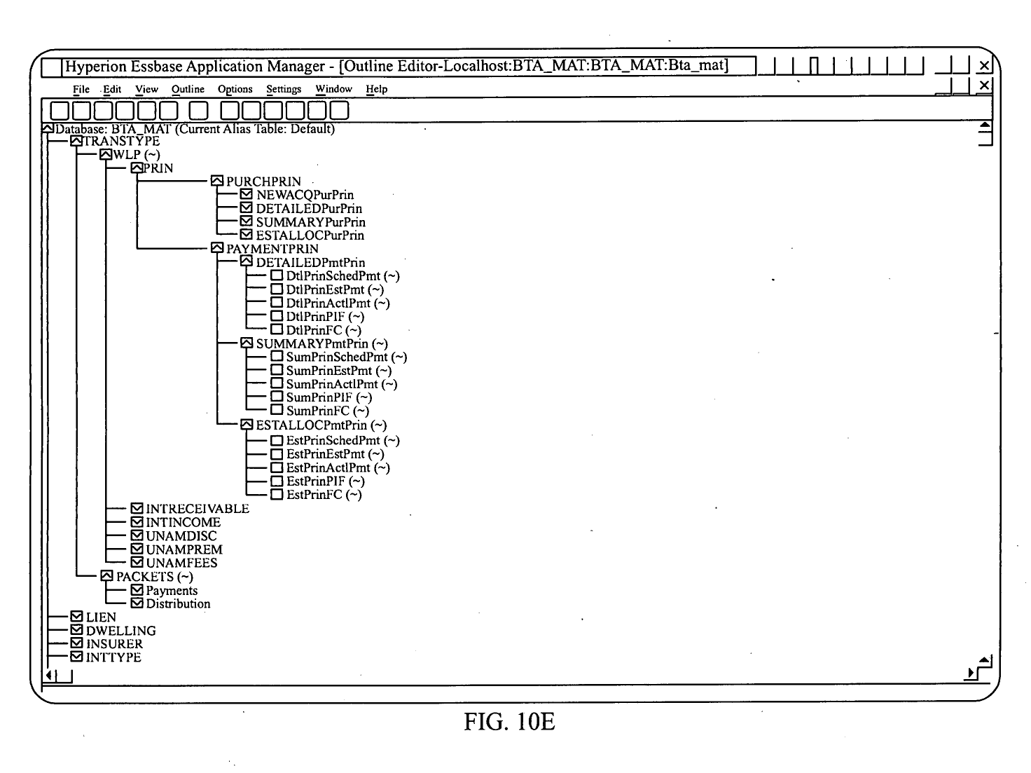

Referring to FIGS. 10A-10E, one embodiment of accounting matrix 260 is shown in a number of screen displays of a computer which is configured to operate by reading computer readable instructions, which include accounting logic 256. FIG. 10A shows a screen display of the families used in this embodiment. The families shown in FIGS. 10A-10E generally correspond to the families shown in table 250. FIGS. 10B-10E show further screen displays of various levels or groups of the transaction type family as it is drilled into. In FIG. 10A, only the first level of family members for the various families are shown. In this embodiment, the family members or attribute values of the transaction type family are grouped at various levels for convenience (e.g., simpler organization in light of the large number of transaction types that may be processed using the accounting matrix 260, etc.). The remainder of the families are not divided into levels since, in this embodiment, the number of allowable values for the individual families other than the transaction type family is relatively small. As shown in FIG. 10A, the first level of the transaction type family differentiates between whole loan portfolio (WLP) and packets. In FIG. 10B, the next level of hierarchy for the transaction type family shows the various family members that are grouped as either whole loan portfolio or packets. The packets family members are divided into payments and distributions and represent transactions that typically occur in connection with MBS. The whole loan portfolio may be further divided into additional levels as shown in FIGS. 10C-10E.

As shown in FIGS. 10A-10E, the family members of particular families may be grouped and nested to provide additional sorting and organizational capability to the accounting matrix 260. Although the transaction type family is shown to include grouped and nested family members any of the families may include grouped and/or nested family members. In one embodiment, the accounting matrix 260 is configured so that for a particular transaction each family may only be identified by a single value (e.g., for a particular transaction the conduit family cannot be both HTM and AFS, which are shown in table 250 as being separate values, unless that combination of separate values is defined as a single value, e.g., HTMAFS).

For business activities that are input into data processing system 12 that produce an accounting relevant transaction, a transaction record containing the transaction's attribut e values (family members) for each family in the accounting matrix 260 is created. The transaction record is then processed using the accounting matrix 260 to make the appropriate accounting entries on the sub-ledger 264 and/or general ledger 266.

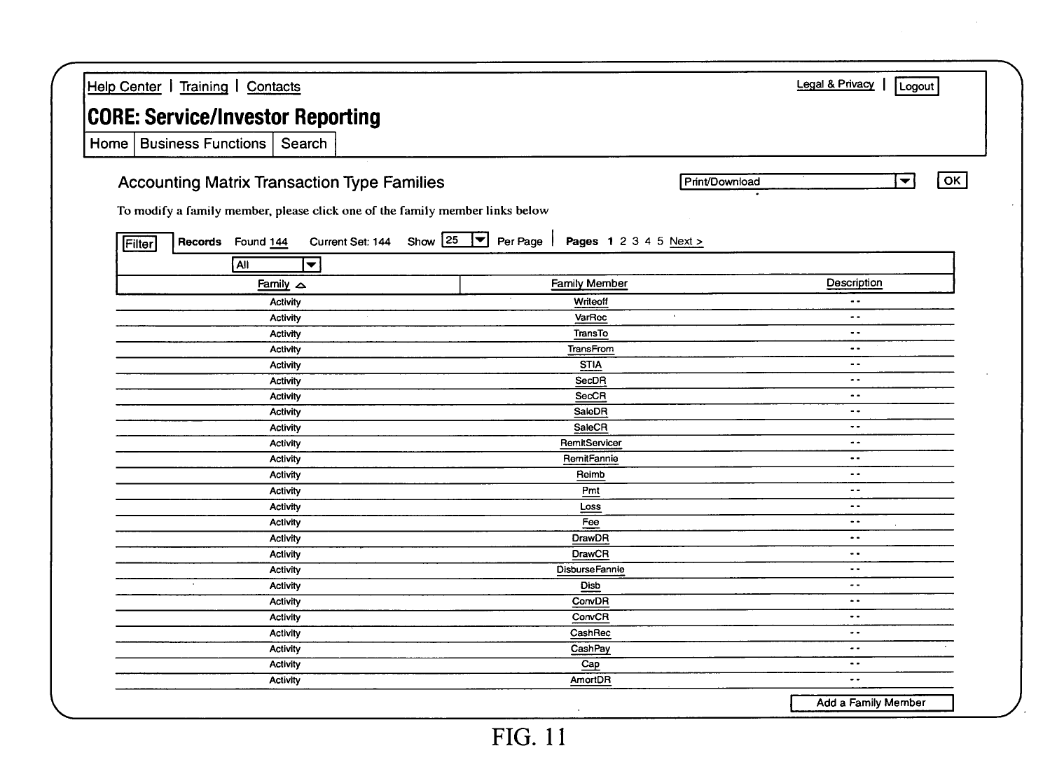

Referring to FIG. 11, a screen shot is shown of one embodiment of a data processing system 12 which includes accounting logic 256. The screen shot shows a table which includes three columns. The first column shows the family. The second column shows individual family members that are included in the particular family. The third column is used to display a description of the family members. In the screen shot, the transaction type or activity family is shown with selected family members. As shown in the screen shot, the number of family members for the activity family is one hundred and forty four. A user presented with this screen has the option to modify the family members by clicking on the text of the family member. By clicking on the family member, the user is directed to another web page where the particular family member may be modified.

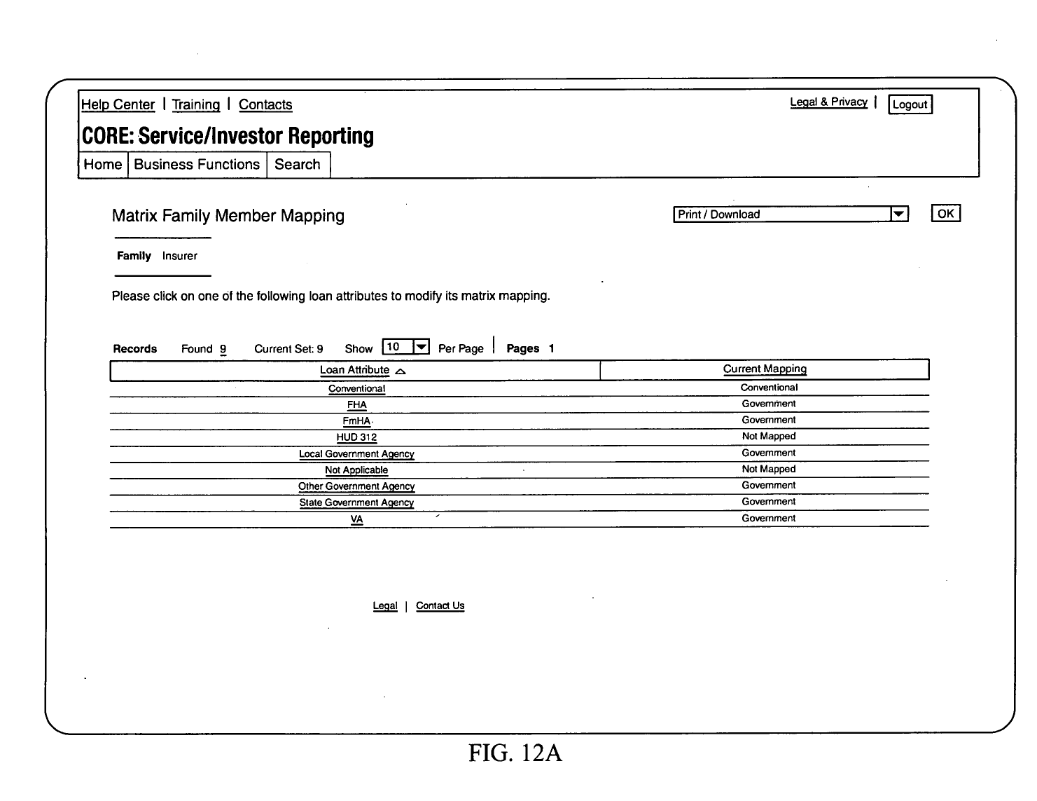

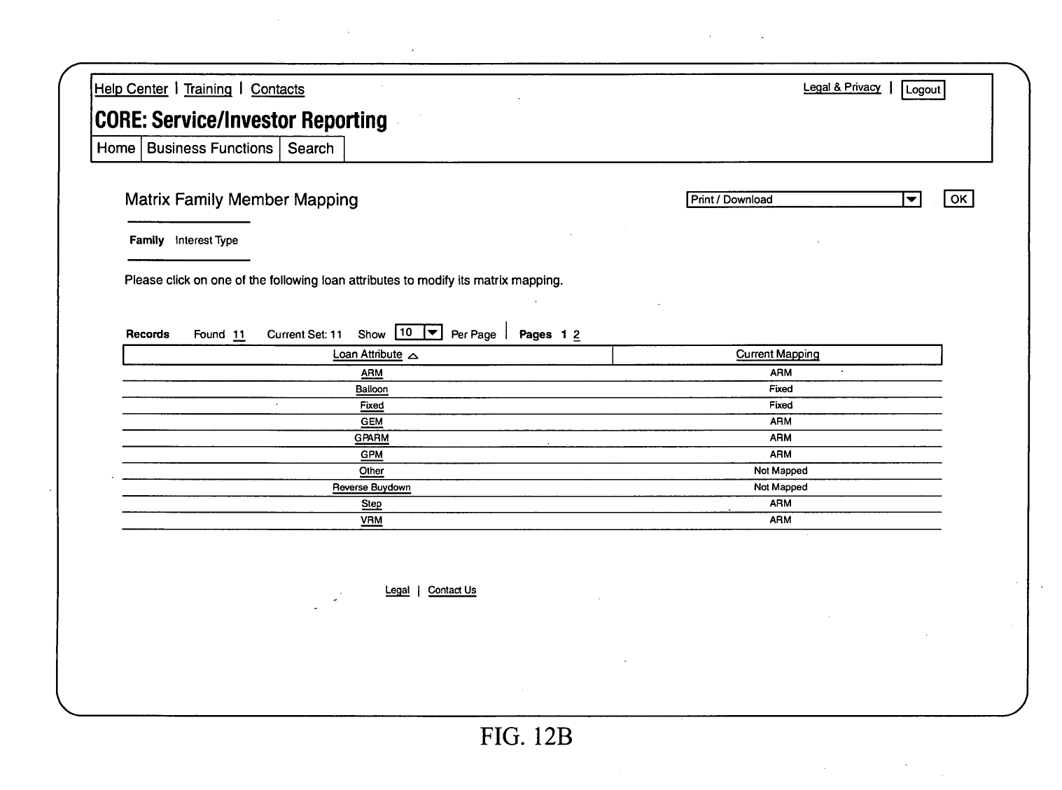

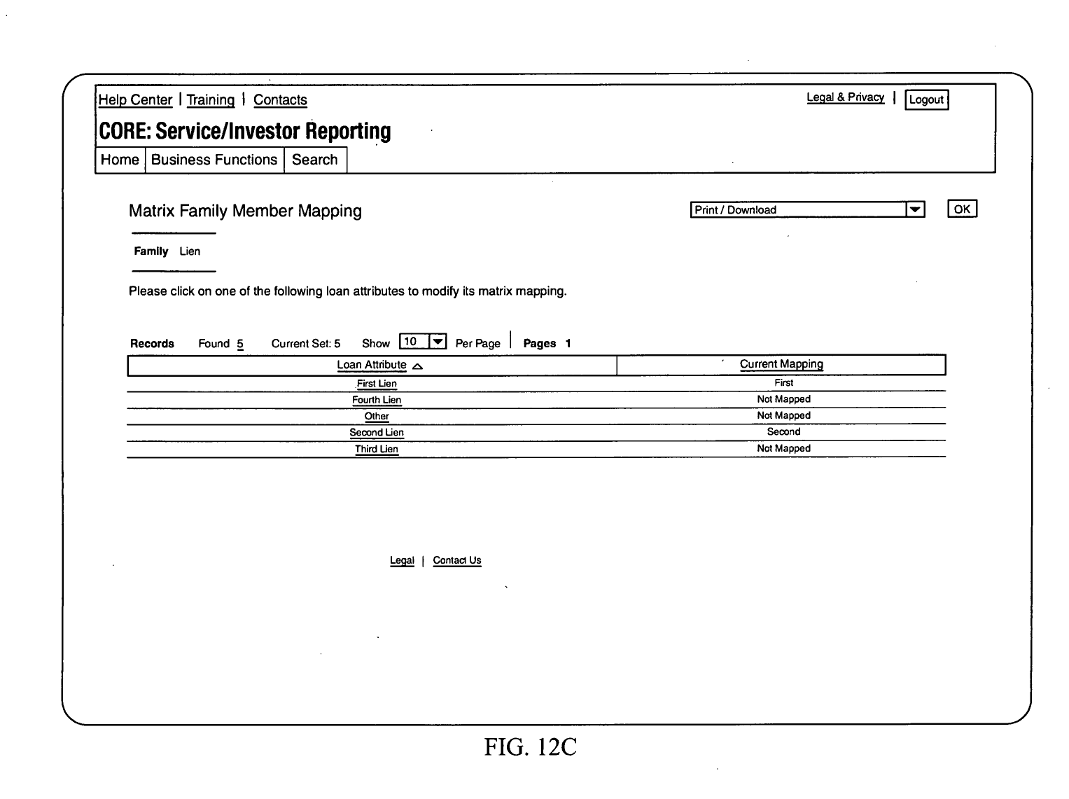

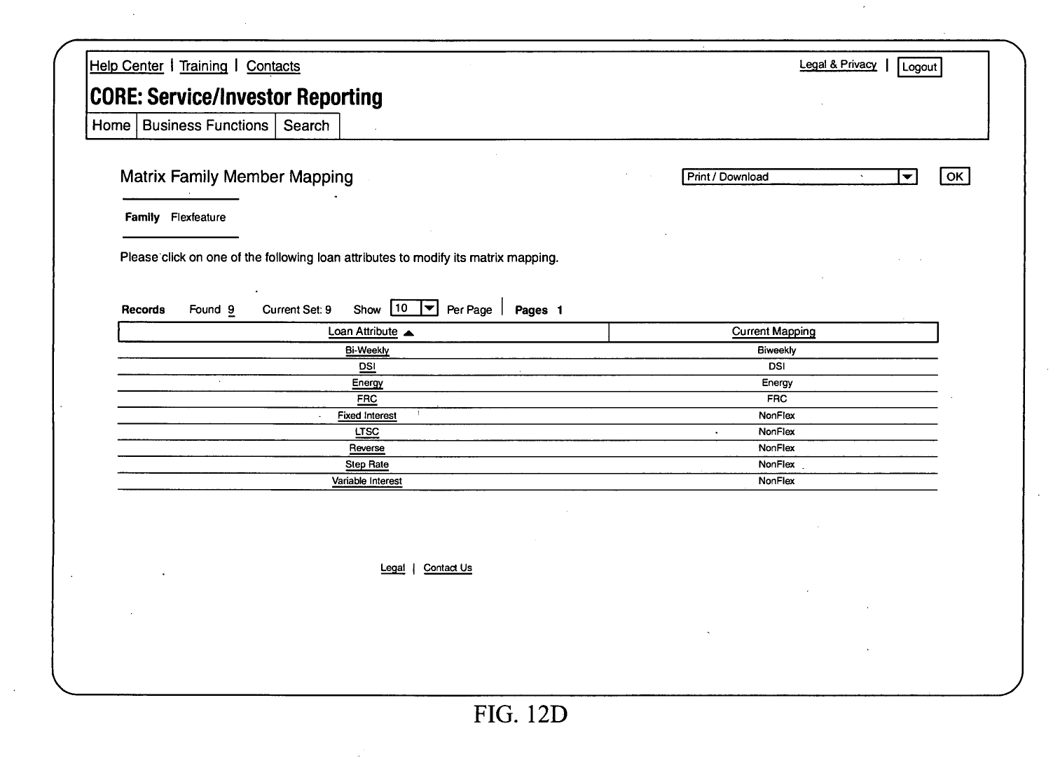

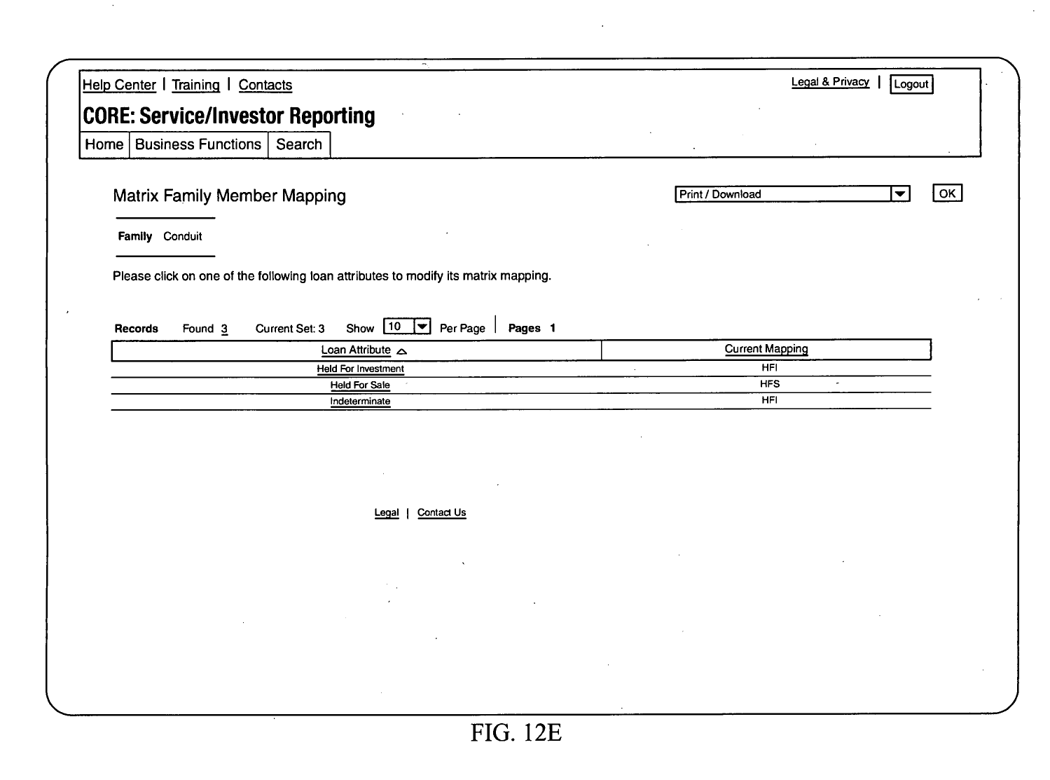

Referring to FIGS. 12A-12E, a number of screen shots showing the particular attribute values of a transaction for a particular family and the grouping of those attribute values into levels of attribute values are shown. The screen shots are generally formatted as a table with two columns. The first column shows the lowest level of attributes that may apply to a particular transaction and the second column shows a higher level grouping of attribute values to which each lower level attribute value is grouped with. For example, one or more of the lower level attribute values may be grouped into a higher level attribute value. In FIG. 12A this is illustrated by the lower level attribute values of FHA, FmHA, Local Government Agency, Other Government Agency, State Government Agency, and VA being grouped into a higher level attribute value identified as Government. The groups and levels shown in FIG. 12A are similar to the manner in which the attribute values are grouped in FIGS. 10A-10E. In FIG. 12A, however, the higher level attribute value (e.g., Government or Conventional) are used to determine the accounting treatment of the particular transaction.

It should be understood that in other embodiments, the lowest level of attribute values may be only those attribute values that are desired or needed from an accounting perspective. Although it is not necessary to further divide the attribute values that are used by accounting matrix 260 into additional levels or groups, this may be desirable in that additional information about the transaction is maintained in system 12 even though the information is not required by the accounting matrix 260. Also, in many situations, the lower level attribute values are often more descriptive of a particular transaction than the attribute values used by accounting matrix 260. Thus, it is easier for a user to enter in transaction information using the lower level attribute values. Accounting logic 256 is left to associate the appropriate lower level attribute values (e.g., FHA) with the higher level attribute values (e.g., Government) used by the accounting matrix 260. In addition, it may be desirable to track information in other areas of data processing system 12 using the lower level attribute values. Thus, providing various levels or groups of attribute values, any one of which may or may not be used by accounting matrix 260, is a simple way to process the transaction data in both the data processing system 12 and the accounting logic 256.

FIGS. 12B-12E are similar in layout to FIG. 12A. FIGS. 12B-12E, respectively, show various lower level attribute values and higher level attribute values that each lower level attribute value is mapped to for the following families: interest type (FIG. 12B), lien (FIG. 12C), flexfeature (FIG. 12D) (or special feature as it is referred to in table 250 in FIG. 9), and conduit (FIG. 12E). This list of families is only one of an almost limitless number and/or combinations of families that may be included in accounting logic 256. As shown in FIG. 12B, the interest type family comprises the following accounting relevant attribute values: ARM and fixed. The lower level attribute values associated with the ARM family member include ARM, GEM, GPARM, GPM, Step, and VRM. The lower level attribute values associated with the Fixed family member include balloon and fixed. The lower level attribute values that are not mapped include other and reverse buydown.

Referring to FIG. 12C, the lien family comprises the following attribute values: first and second. The lower level attribute value entitled “First Lien” is associated with the higher level attribute value “First” and the lower level attribute value entitled “Se cond Lien” is associated with the family member of second. The lower level attribute values entitled “Third Lien” and “Fo urth Lien” are not yet mapped to a higher level attribute value. FIGS. 12D and 12E shows similar results for the families of flexfeature and conduit, respectively.

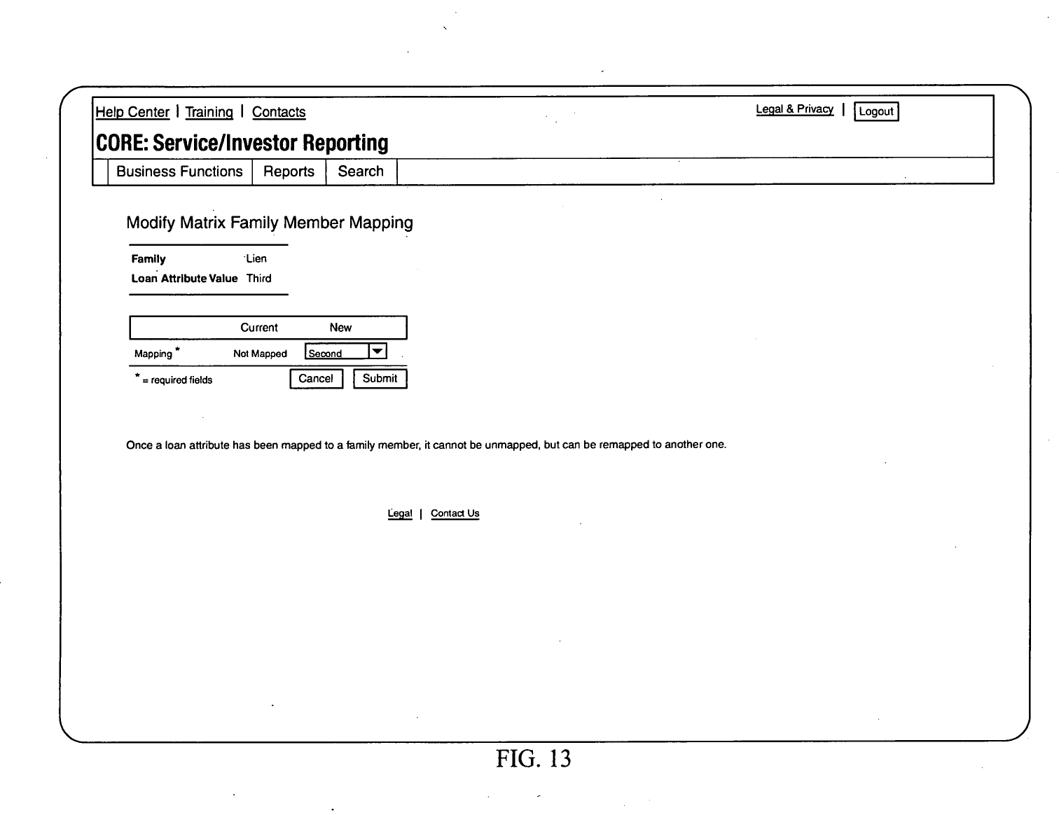

The screen shot shown in FIG. 13 is used to change the higher level attribute value that a lower level attribute value is mapped to. This screen may be displayed when the user selects (e.g., clicks on the link) an attribute value from the screen shots shown in FIG. 12. In the example shown in FIG. 13, the lower level attribute value “Third” from th e lien family is being modified. As shown, the attribute value “Third” is not presently mapped. In this example, the user is presented with a drop down box 280 from which the user can select the appropriate higher level attribute value to which to map the “Third” attribute value.

As new business and/or products types are created, the accounting matrix 260 may be modified in order to properly journalize the new business activity. Typical reasons for modifying the accounting matrix 260 may include accommodating accounting treatment changes, modifications to the appropriate ledger categorization for current products, the introduction or discontinuance of products, and so on. In one embodiment, the accounting matrix 260 is modified by a user to accept and account for new products. In another embodiment, the accounting matrix 260 may be configured to accept transactions from new products automatically and simply enter a default value for the new attributes and/or attribute values of the products that may not be in the accounting matrix 260.

User access for the purpose of modifying the accounting matrix 260 (or potentially for any other purpose described herein) is preferably restricted to select employees within the purchaser to prevent unauthorized access and modifications. Of course, in other embodiments, a large group of employees of the purchaser or even third party users and employees may also have some limited access to modify or view aspects of the accounting matrix 260.

The accounting matrix 260 may be configured so that modifications are not immediately implemented but are instead implemented at a certain predetermined time (e.g., beginning of a new fiscal year, quarter, month, other accounting period, etc.). Therefore, at any given time only one version of the accounting matrix 260 is in use and the version may be easily changed at the desired time.

New business or product types may require new attribute families or, more often, new members of existing families to be added to the accounting matrix 260. This trigger may occur “pr oactively” by the purchaser planning a new product and modifying the accounting matrix as part of the roll-out of the new product. The trigger may also occur “reacti vely” when the accounting logic 256 is unable to match transaction attributes and/or attribute values to the attributes and/or attribute values used in the accounting matrix 260.

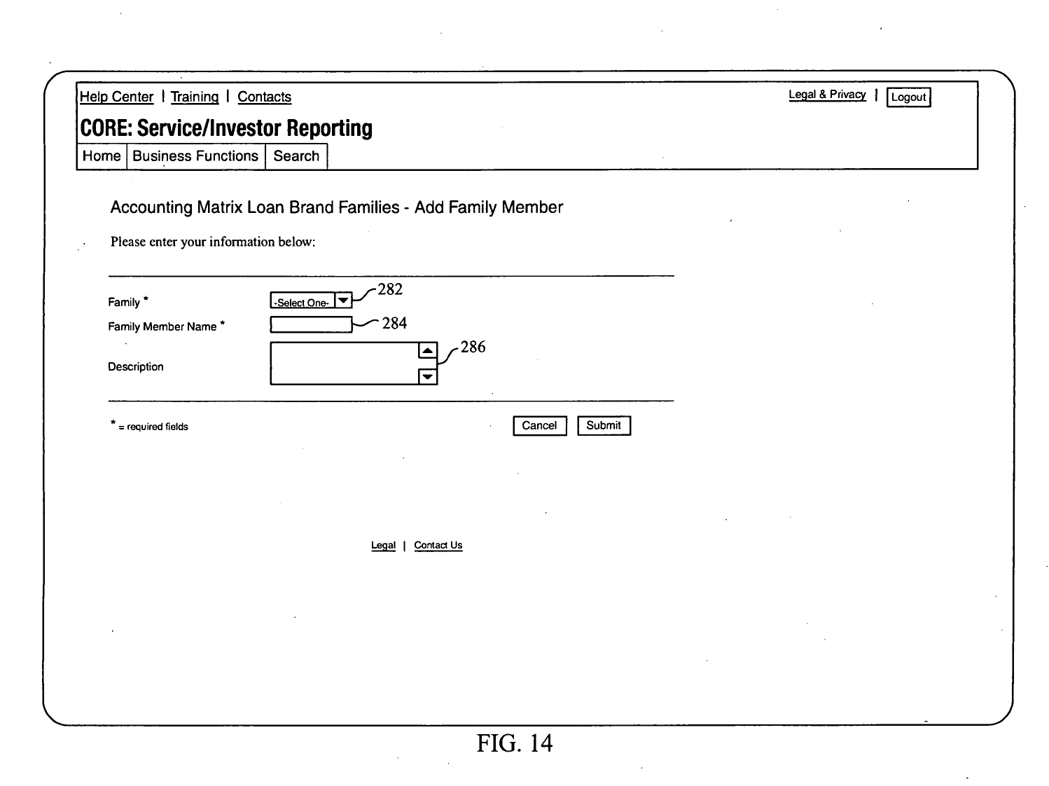

In many situations, new products or business types require new families and/or family members to be added to the accounting matrix 260. FIG. 14 shows one embodiment of how a user may modify accounting matrix 260 by adding a new family member to an existing family. In this example, the user is presented with a first drop down box 282 where the user selects the family to which a new family member is to be added. In a text box 284, the user enters the name of the family member to be added to the selected family. In text box 286, the user is given the option of providing a description for the new family member. In this manner, the user is able to simply and easily modify the accounting matrix 260.

In one embodiment, before adding new families and/or family members, the accounting logic 256 may be configured to determine whether the product attributes already exist in the accounting matrix. The accounting logic 256 may do this by comparing the stored families and family members to the newly entered family and/or family members. If a user is entering the new family and/or family member then accounting logic 256 may be configured to display a list of other families and/or family members that are closely related to the newly added family and/or family member and allow the user to verify that the new family and/or family member does not exist already. In other embodiments, the user may confirm that a new family and/or family member does not already exist in the accounting matrix without assistance from the accounting logic 256. In other embodiments, the accounting logic 256 may be configured to check that the new family and/or family member does not already exist without any input from the user. Other suitable methods may be used also.

In one embodiment, accounting logic 256 may be configured to automatically associate suspense account numbers with any combination of families and family members that include the newly added families and/or family members. A user may then modify the accounting matrix 260 to replace the suspense account number with the appropriate ledger account number for each of the new combinations of families and family members. In another embodiment, the accounting logic 256 may be configured to associate a suspense account to a particular combination of families and family members upon receiving a transaction having that combination (provided the combination is not already associated with a credit and/or debit account number). Accordingly, the accounting matrix 260 only includes suspense account numbers for those combinations of families/family members not already associated with a credit and/or debit account but for which there is a transaction that needs to be or was processed. If a transaction has never been received for a particular combination and it is not associated with a credit and/or debit account then it also is not associated with a suspense account until a transaction is received having that combination of attributes and attribute values. In yet another embodiment, the accounting logic 256 may be configured to automatically provide the appropriate account numbers for the various combinations of families and family members that include the newly added family and/or family member (rather than suspense account numbers) based on predetermined rules that are included as part of accounting logic 256. Also, in still another embodiment, when new families and/or family members are added, the user may be required to input the appropriate account numbers for combinations of families and family members that include the newly added family and/or family member.

An example of a proactive modification of the accounting matrix 260 is provided as follows. If a new loan type is purchased that is collateralized by a mixture of FHA insured and conventional properties, and this loan needs to be categorized separately on the appropriate ledger, then a new family member would be added to the insured family (family 3 in FIG. 8), “hybrid.” All of the combinations of families and family members which include “hy brid” as the insurer family member are automatically populated with the appropriate suspense account numbers.

There may be instances where new products or business activities generate transactions which include attributes and attribute values that are not included in the accounting matrix 260. These transactions may be processed by accounting logic 256 without prior notification being given to the purchaser that these are new products or business activities. Consequently, as the transactions are input into the accounting logic 256, it fails to match the attributes of the transaction to the combinations of families and/or family members included in the accounting matrix 260. In one embodiment, the accounting logic 256 is configured to dynamically add the unknown family and/or family member to the accounting matrix 260 and populate newly created combinations which include the newly added family and/or family member with the appropriate suspense account numbers.

In another embodiment, the new attribute of the transactions generated by the new products and/or business types may be compared to the families and/or family members that are used by accounting matrix 260. If there is not a match, then the accounting logic 256 recognizes that there is a problem and notifies a user. The user may research the problem to determine its source and remedy the problem. The problem may be remedied by the user simply verifying that the correct families and/or family member has been automatically mapped to the new attribute. In other instances, the problem may be remedied by replacing the suspense accounts entered automatically by the accounting logic 256 with ledger account numbers.

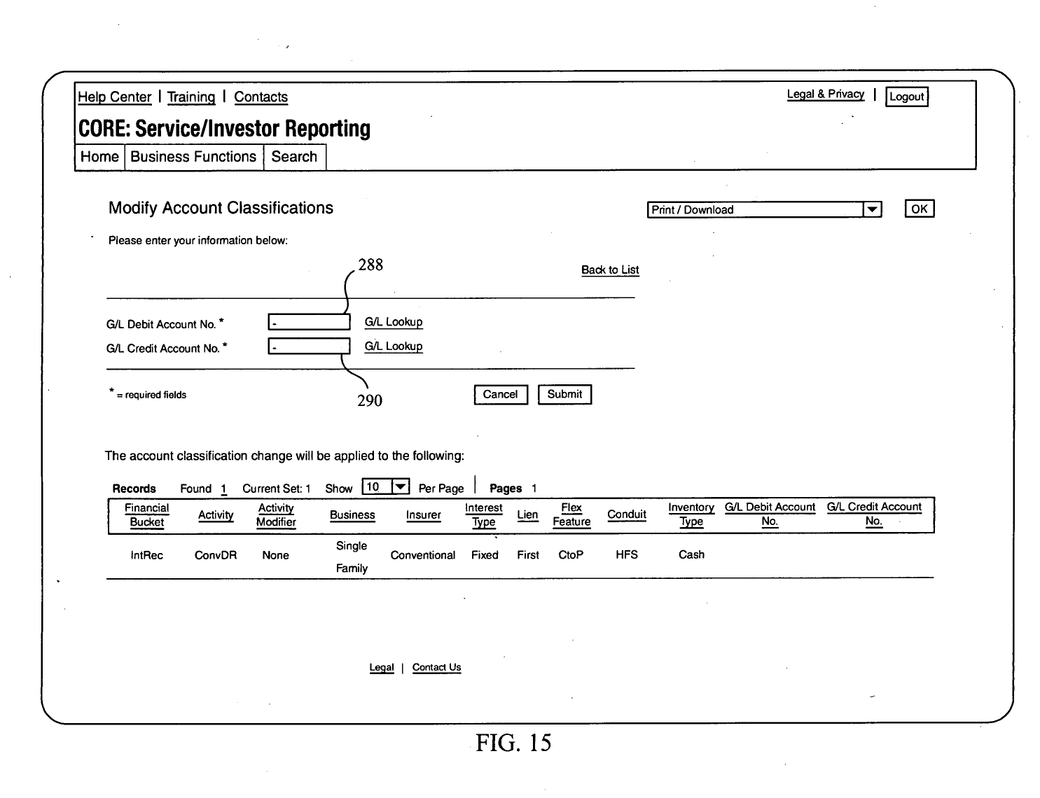

The accounting matrix 260 may also need to be modified on occasion to accommodate accounting methodology changes, incorrect debit and credit account number assignments, differences (or eliminate the differentiation) between existing products, or elimination of products on the general ledger. As shown in FIG. 15, the accounting logic 256 may be configured to allow a user to modify the existing accounting structure (e.g., change the general ledger account numbers or change the accounting matrix 260 to account for certain transactions, packets, or loan attributes differently). The screen shot in FIG. 15 shows a selected combination of attributes and attribute values included in accounting matrix 260. Text boxes 288 and 290 may be used to enter new debit and credit account numbers to associate with this particular combination of attributes and attribute values. In one embodiment, changes to the accounting structure only take effect once they are approved. In other embodiments, the changes may take effect immediately.

In situations where changing the account structure results in a remapping of an existing sub-ledger balance to a new general ledger account, the accounting logic 256 may be configured to automatically generate the appropriate reclassification entries in the sub-ledger 264, which are eventually passed to the general ledger 266. In one embodiment, the accounting logic 256 is configured to prevent members of a family from being deleted if sub-ledger balances associated with the family/member slated for deletion exist. In order to delete the family/member, the balances associated with the family/member to be deleted may be reclassified to other existing and/or new accounts on the appropriate ledger. Once the balances have been reclassified, then the accounting logic 256 would permit the family and/or family member to be deleted.

Typically, changes to the accounting matrix 260 are the result of an accounting methodology change. However changes may also be triggered by the discovery of an incorrect setup or the removal of obsolete markers. Any of these triggers may invoke the process of modifying one or more families and/or family members.

Journal entries to the sub-ledger 264 and the general ledger 266 may be created using the accounting logic 256. The accounting logic 256 includes a sub-ledger 264 where the journal entries are temporary, more detailed, and/or subject to analysis (e.g., reconciliations, etc.) and change. Once the journal entries are verified they may be used to update the general ledger, typically at the end of an accounting cycle. The general ledger 266 is typically what is used by the purchaser to create annual reports, analyze past performance, project future performance, etc.

Creating and entering the journal entries is typically a two-step process. The first step is to assign the appropriate debit and credit account numbers to each of the transactions as they are processed using the accounting matrix 260. In one embodiment, the accounting matrix 260 automatically assigns the appropriate account numbers as the transaction is processed. One goal of interpreting transaction attributes through the accounting matrix 260 is to assign debit and credit account numbers to transactions on the sub-ledger 264 and/or general ledger 266. By comparing attributes and attribute values of a transaction with the combinations of attributes and attribute values in the accounting matrix 260, the accounting and the transactions become fused, rather than performing accounting as a separate or after-the-fact process. The sub-ledger 264 provides an accurate and up-to-date accounting picture. Also, the sub-ledger 264 is poised to update the general ledger 266 with whatever frequency is deemed desirable (e.g., yearly, quarterly, monthly, weekly, daily, hourly, etc.).

As part of assigning debit and credit accounts, or creating journal entries at the sub-ledger level, the accounting logic 256 also performs a data integrity check on the sub-ledger 264. Tools may be built into the book and tax accounting logic 146 to identify, analyze and resolve exceptions to the data integrity check. By dynamically performing this function, the latency problem in identifying exceptions is vastly improved and, therefore, system issues in posting accounting entries are addressed promptly.

The second step of the journal entry process is to update the purchaser's fina ncial reports. This may entail consolidating the debits and credits for each account number on the sub-ledger 264, and summarizing the journal entries up to various levels as may be desired. In general, the hierarchy of the transaction type family is a logical mechanism to assign what activities go with a particular journal entry number. A unique journal voucher identification (JVID) number is assigned for cash estimates (and reversals), accruals, servicing transactions, acquisition transactions, and securitization transactions. In the same way that a high level of the hierarchy denotes what suspense accounts to assign to lower level descendants, another level of the hierarchy denotes the journal entry number to which the descendants are mapped. The general description for the journal entry may also be tagged from this level of the hierarchy. The individual line item descriptors may be the lower level transaction types. The entries are then transmitted to the general ledger 266. In one embodiment, the accounting logic 256 provides the flexibility to transmit the sub-ledger entries to the general ledger incrementally (e.g., transmit activity since the previous transmission to the general ledger), and multiple times throughout the period between when the general ledger 266 is regularly updated. This flexibility allows for potential changes in processing journal vouchers, and also allows for distribution of the transmission process throughout the accounting cycle.

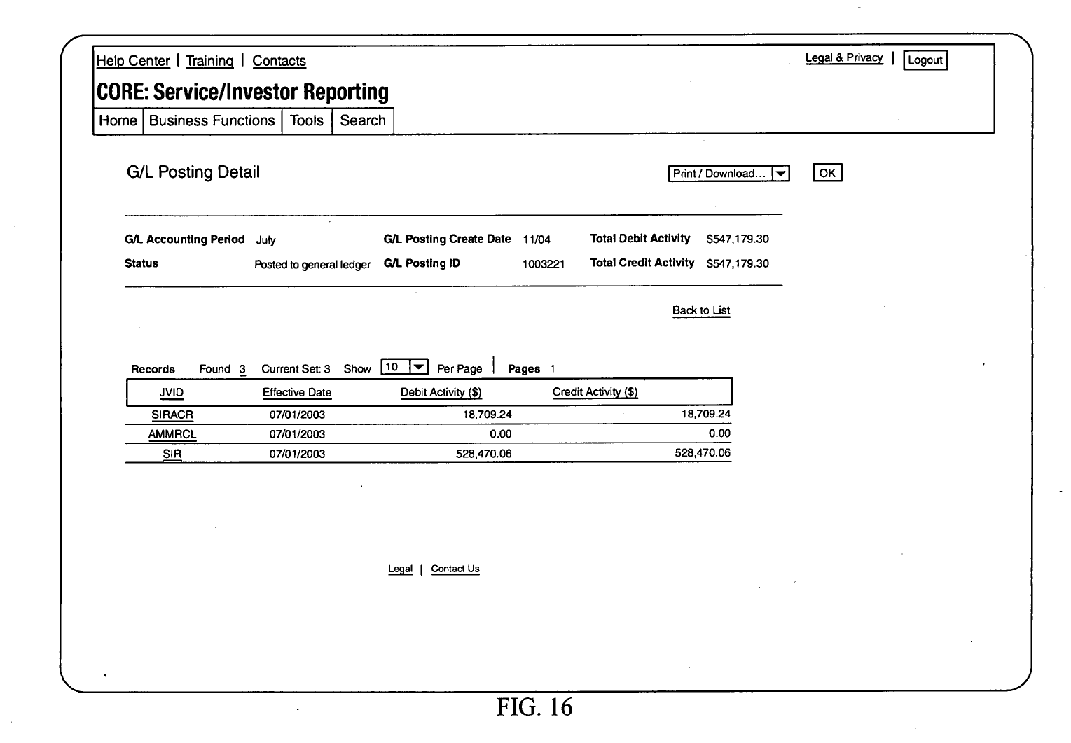

Referring to FIG. 16, a screen shot is shown of posting detail that may be included in the accounting logic 256. In the screen shot, three examples of postings to the general ledger 266 are shown. Each posting is identified by the JVID, the effective date, the debit amount, and the credit amount.

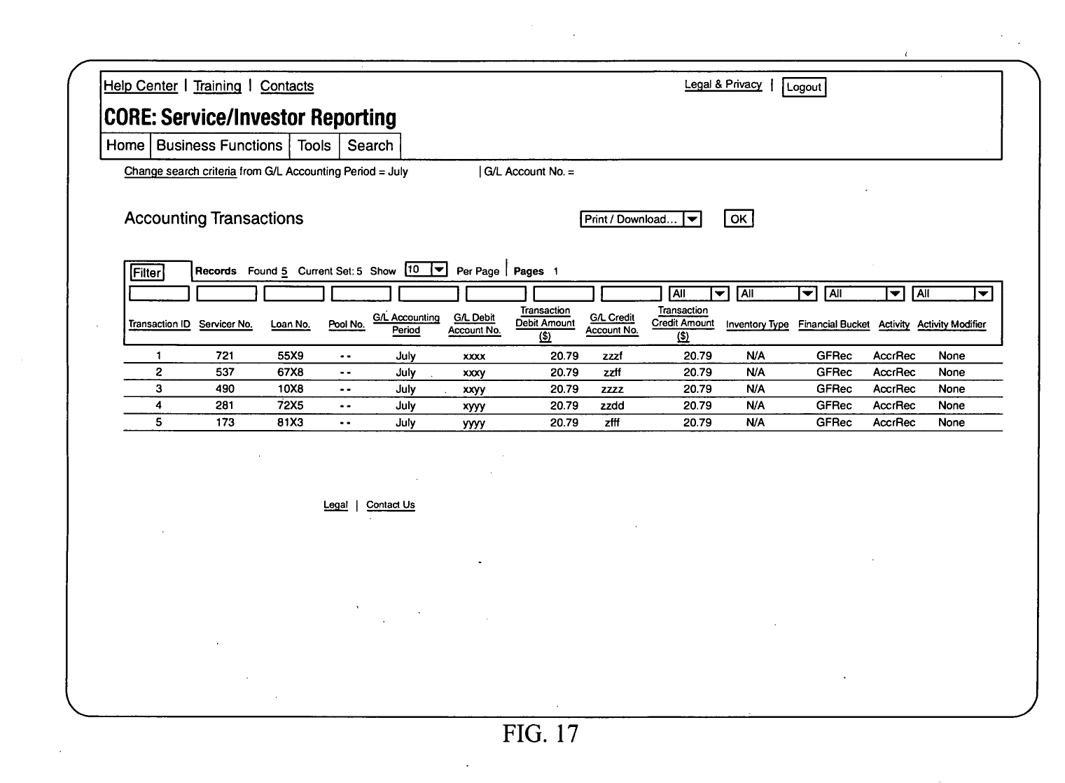

Referring to FIG. 17, the accounting logic 256 may also be configured to provide detail on a number of transactions in an easy to review format. FIG. 17 shows a screen shot of five transactions. Each transaction is shown as a row in a table. The columns in the table represent various information such as the Transaction ID, loan Servicer No., Purchaser's loa n number, accounting period, the appropriate debit and credit accounts, etc.

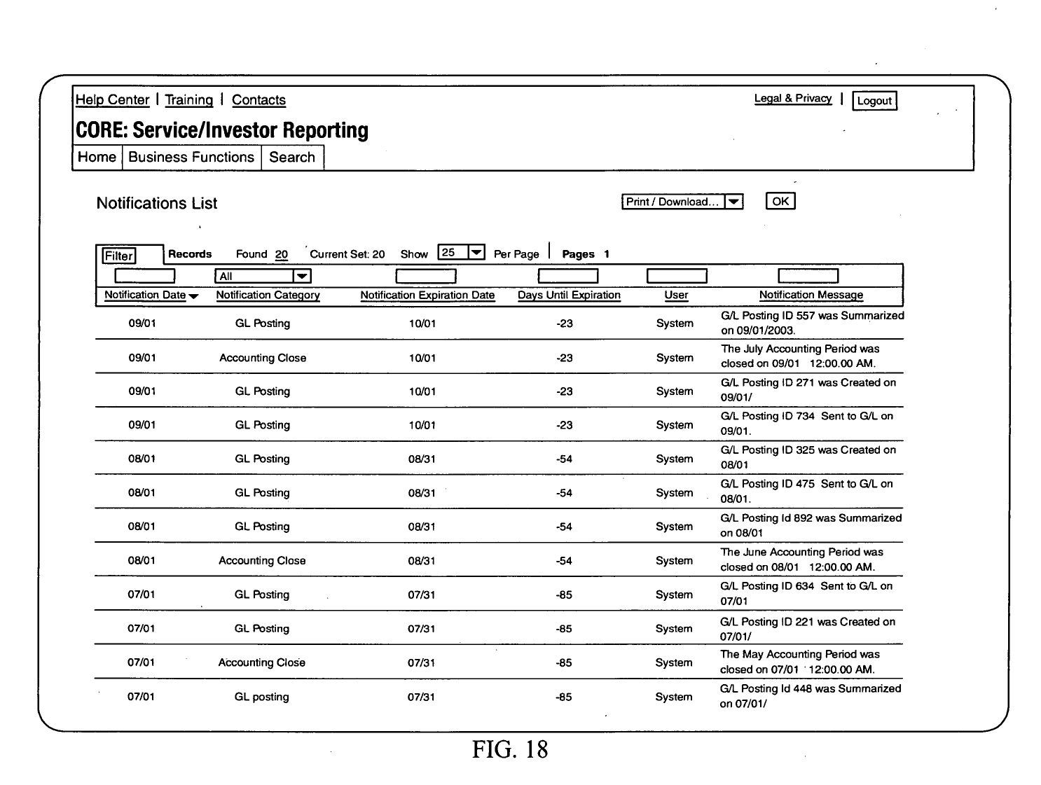

Throughout the accounting cycle, the accounting logic 256 may post (either in response to a command by a user or automatically) the sub-ledger entries to the general ledger 266. The accounting logic 256 consolidates the sub-ledger accounts to the appropriate summary level and submits them to the general ledger 266. In one embodiment, the accounting logic may be configured to notify a user each time the sub-ledger 264 updates the general ledger 266. FIG. 18 shows one example of a list of notifications that may be provided to the user. The list of notifications is shown in table format where each row is a separate notification and the columns identify the date when the notification will expire, a notification message, and the user that is being notified. The notification message may include information such as a general ledger posting identifier and the date which the posting occurred, etc.

There may be a number of methods for posting sub-ledger entries to the general ledger. Two methods are described herein: “full—incremental” (not closing out the accounting cycle) and “clos eout the accounting cycle.” The accounting logic 256 provides a facility to identify each posting to the general ledger 266. By identifying each posting, the user or accounting logic 256 may be able to undo post entries or modify entries previously posted.

In the closeout the accounting cycle method, the accounting logic 256 is scheduled to close out the accounting cycle periodically. The close out events generally signify an accounting break period (e.g., end of fiscal year, quarter, etc.) For the remainder of this description it is assumed that the accounting cycle is monthly. However, other accounting cycles may also be used. In one embodiment, the accounting logic 256 is configured to provide for user override of the scheduled close out. The override may be configured to push the close out back one day, one week, or any other desired time period. Also, the override may be invoked an indefinite number of times to provide increased flexibility. In other embodiments, the override may only be invoked a predetermined number of times (e.g., once, twice, etc.).

The closeout of the accounting cycle triggers several related events. The cash allocation estimate is calculated and booked. Once that is done, interest accruals are calculated and booked. Once most of the events are booked, standard reports are produced in final form. In one embodiment, if the closeout is a yearend closeout, balances for income and expense accounts on the sub-ledger 264 may be set to zero. This may be accomplished through a special transaction that “mov es” income and expense to retained earnings. However, this is typically only done for the sub-ledger 264 and is not passed on to the general ledger 266. Therefore, this transaction type is a sub-ledger 264 only booking. Typically, there are very few sub-ledger 264 only bookings. However, in other embodiments, it may be desirable to provide for a substantial number of sub-ledger 264 and/or general ledger bookings.

In certain instances, it may be desirable to undo a posting from the subledger to the general ledger. This may be desirable because of errors in the data or because incomplete data was posted. Accordingly, the accounting logic 256 may be provided with the capability to undo a post.

The accounting logic 256 may also include mechanisms that identify operational exceptions as soon as possible and resolve them before they become financial risks. The accounting logic 256 may be configured to provide the desired control of the processes involved in receiving transactions and creating corresponding journal entries to respond to operational exceptions before they become serious problems. In one embodiment, exception items are those items that are posted to the sub-ledger suspense account or items causing the sub-ledger to not “walk forward.” Once the accounting logic 256 identifies one of these exceptions, a user may be notified to research the problem, the accounting logic 256 may automatically resolve the problem, or a combination of user input and accounting logic 256 may be used to solve the problem.

The accounting logic 256 may use a reconciliation facility 268 to compare the sub-ledger 264 to the general ledger 266 to identify any inconsistencies. For example, the accounting logic 256 may compare the sub-ledger activity and account ending balances to the general ledger activity and account ending balances. Once again, the accounting logic 256 may be configured to notify the appropriate person to research the problem, automatically resolve the problem, or a use a combination of both of these approaches.

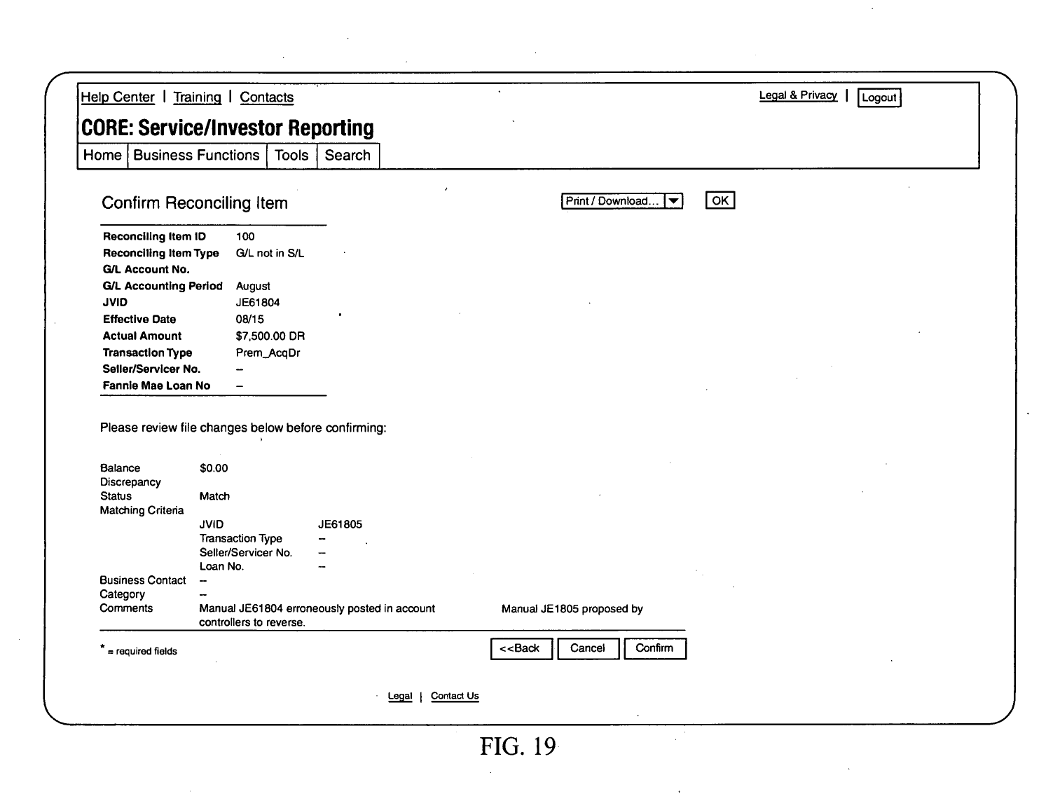

FIG. 19 shows one example of a screen shot of a reconciliation report generated using the reconciliation facility 268. The report is generated when there is problem reconciling the general ledger 266 and the sub-ledger 264. As shown in FIG. 1 9, the problem is identified as being an entry that is on the general ledger 266 but not on the sub-ledger 264. The various attributes of the transaction that caused the problem are also identified (e.g., transaction amount, general ledger account number, etc.). As shown a cause of the problem is identified and a solution is proposed. The cause and/or the solution may be identified by the user or, in other embodiments, using accounting logic 256. The cause of the problem in the example shown in FIG. 19 is an erroneous entry on the general ledger 266. The proposed solution is to create a new entry that cancels out the old entry

The accounting logic 256 may also include a reporting function 262 which is used to perform research, validate data, perform reasonability tests, assist in performing accounting reconciliations, track exceptions, perform financial and operational analyses, document events for audit trail purposes, and support other reporting requirements of the various users. The reporting function 262 encompasses printed reports, on-line displays and interactive reporting facilities. Typically, the user has the ability to generate reports on demand. In one embodiment, specific end of cycle reports are stored for viewing on line to minimize printing and accelerate distribution. The on-line displays may be printed locally on demand.

In one embodiment the accounting logic 256 may include an accounting console reporting function. The accounting console is an on-line/real time management information and workflow tool that serves to notify and report process status of accounting and tax related activities. It also serves as the facility to perform exception and reconciliation processing. The information available in the accounting console may be restricted based on a user's ac count permissions. Thus, a manager may see all of the information for the transactions he or she is responsible to manage. The accounting console may include summaries for suspense accounts, aged reconciling items, walk-forward exceptions, and system matched items. Other summaries that may be desired may also be included. In one embodiment, the summaries are provided with the ability to drill down to the lowest level and sorting at every level of granularity.

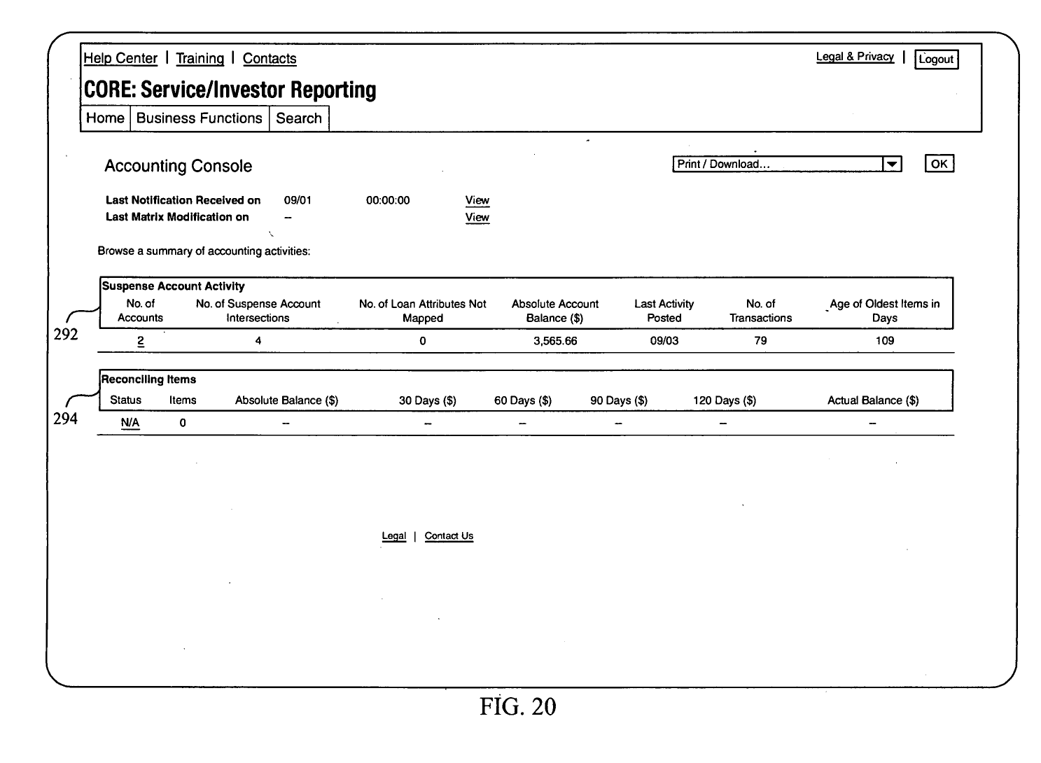

One example of the accounting console is shown in FIG. 20. FIG. 20 shows two tables 292 and 294. The first table 292 shows information related to suspense account activity such as the number of suspense accounts, number of combinations of families and family members which include a suspense account, number of attribute values not mapped (e.g., lower level attribute values that are not mapped to higher level, accounting relevant attribute values), total balance in the suspense accounts, last data a transaction was posted, number of transactions using suspense accounts, and the age of the oldest suspense account transaction. The second table 294 shows information related to reconciling items. The total amount of money involved on the ledgers may be shown as well as the amounts that have been unreconciled for 30 days, 60 days, 90 days, etc. The accounting console makes it simpler and easier for the user to manage the suspense accounts and the reconciling of items.

The close cycle process described previously may trigger standard reports related to financial reporting, tax accounting, etc. These reports are recurring reports that would otherwise be created on an ad hoc basis.

In addition to the close cycle reports, users may also have the ability to search and inquiry the data on demand and generate ad hoc reports. For example, users may be able to search at the loan, security, product, product family, attribute, and account levels, including transaction logs. Users may also have the flexibility to filter, sort, calculate data and otherwise manipulate the format of the data to meet their needs. In addition, users may have the ability to export data to standard office software and bookmark queries and searches they often use.

The process of creating journal entries to the sub-ledger is triggered by the entry of one or more transactions into data processing system 12 and consequently into the accounting logic 256. Once a transaction is entered into the accounting logic 256, it is journalized to the sub-ledger 264 by mapping the transaction attributes to the family members in the accounting matrix 260. If the accounting logic 256 is able to match the transaction attributes to the family members, the accounting logic 256 assigns the pre-defined general ledger debit and credit account number, as specified by the accounting matrix 260, to the transaction. The accounting logic 256 performs a data integrity check to verify that the sub-ledger activity “walks f orward” (walk forward generally means: beginning balance+/−activity=ending balance). If the walk forward fails, the accounting logic 256 notifies the appropriate person that there is a walk forward problem. The accounting logic 256 may be configured to notify the person in any of the ways mentioned previously in connection with notification processor 64. In one embodiment, the notification provides the person with enough information to determine where and when the problem occurred—transaction number, account number, loan number, data and time the problem occurred, etc.). Also, in another embodiment, logic 146 is configured to be able to continue to process transactions while the other problem is being resolved. Therefore, identification of walk forward problems does not halt business production of the logic 146 or system 12.

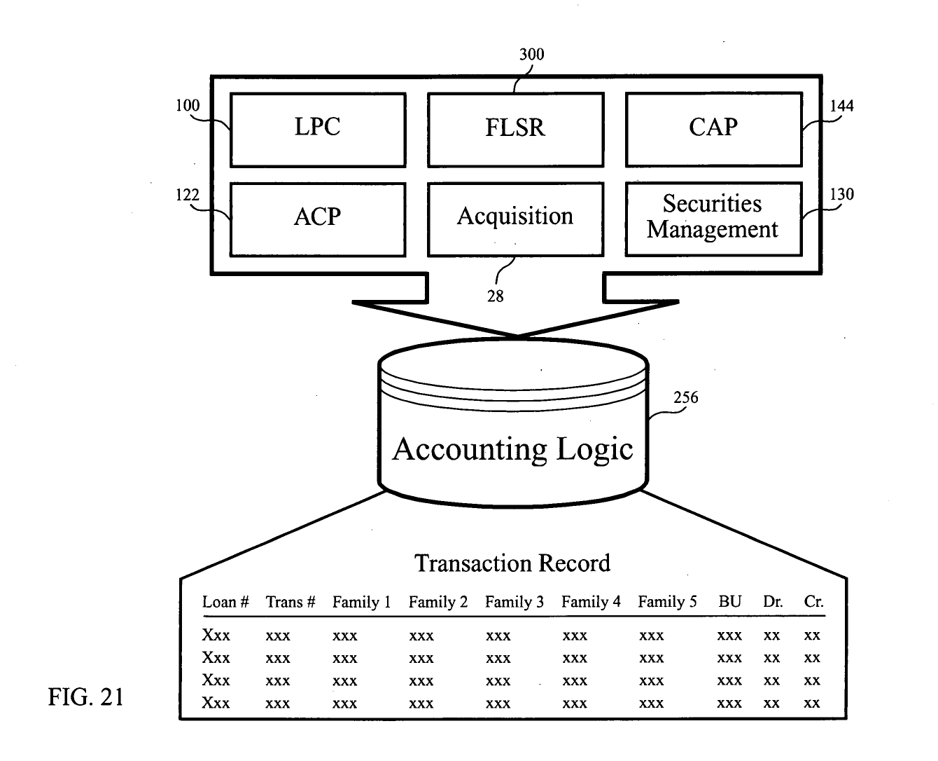

Referring to FIGS. 21 to 29, an example of using accounting logic 256 to process transactions is provided. In this example, accounting logic 256 is configured to receive information from loan process and compare logic 100, attribute change processor 122, acquisition logic 28, cash processor 144, servicing aggregation and management logic 130, or first level security rollup logic 300 (aggregates loan level data to the poll level and processes MBS call-in transactions). Accounting logic 256 may be configured to receive information and/or transactions from any area of data processing system 12.

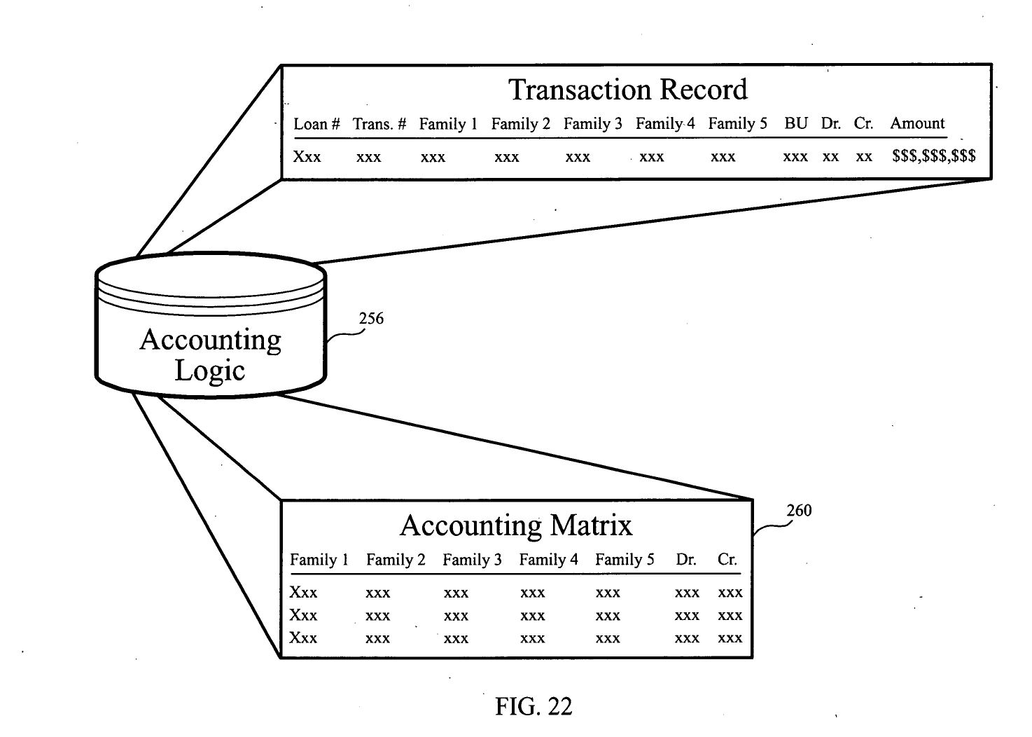

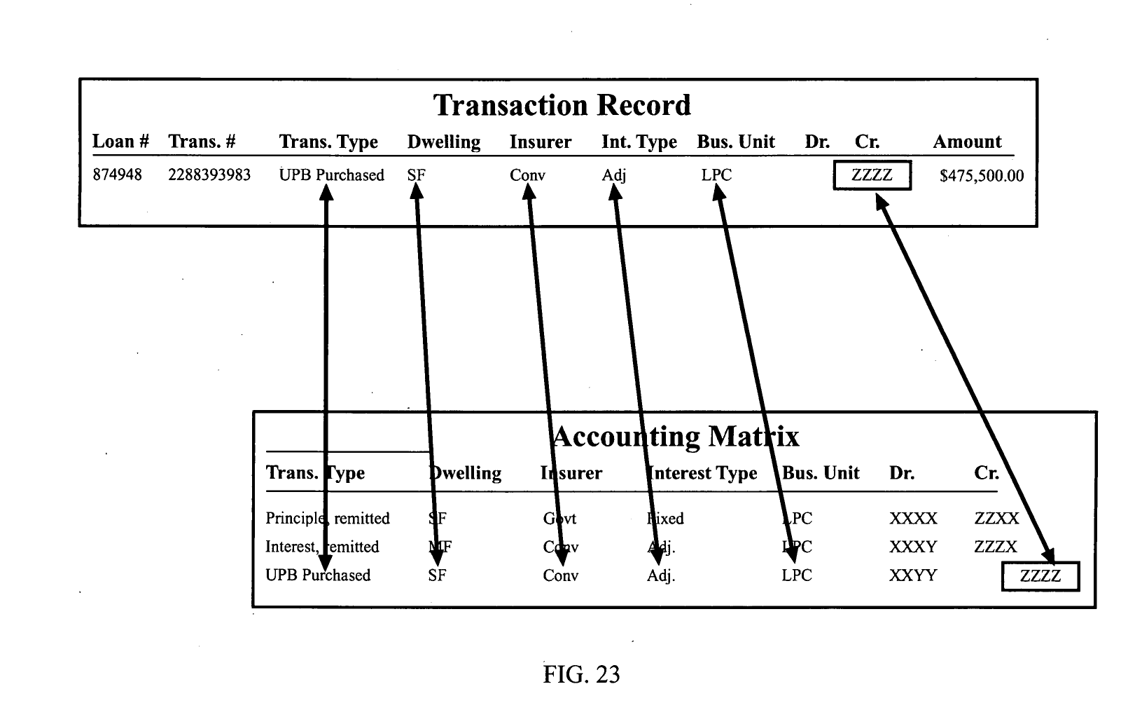

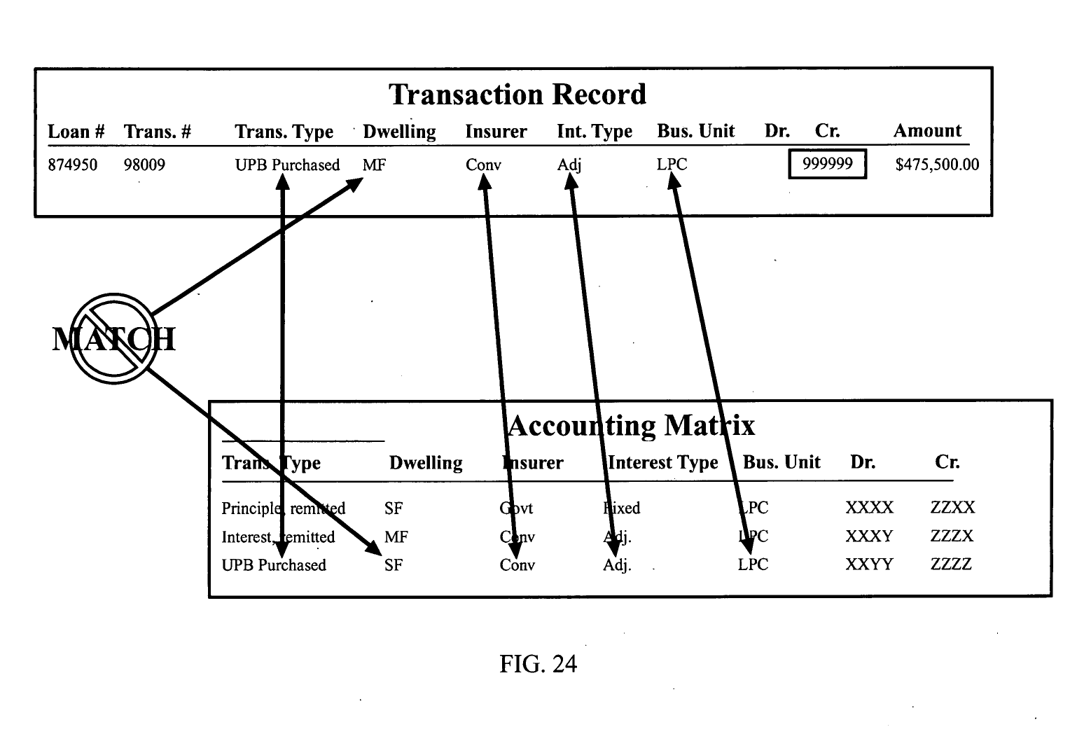

As shown in FIGS. 21 and 22, each transaction is defined in terms of various attributes. As shown in FIG. 23, accounting logic 256 is configured to compare the attributes of the transaction to the combinations of families and family members which are included in the accounting matrix 260. A match is found, as illustrated in FIG. 23, and the credit account associated with that combination of attributes is then associated with the transaction that was entered into the accounting logic 256. FIG. 24 shows a situation where the transaction does not match with any of the combinations of attributes and attribute values in the accounting matrix 260. In FIG. 24, the closest combination in the accounting matrix 260 was the same as the transaction except that the transaction was for a multi-family dwelling and the combination in the accounting matrix 260 was for a single family dwelling. Thus, a suspense account number is associated with the transaction until a user is able to review the transaction and specify the appropriate account numbers.

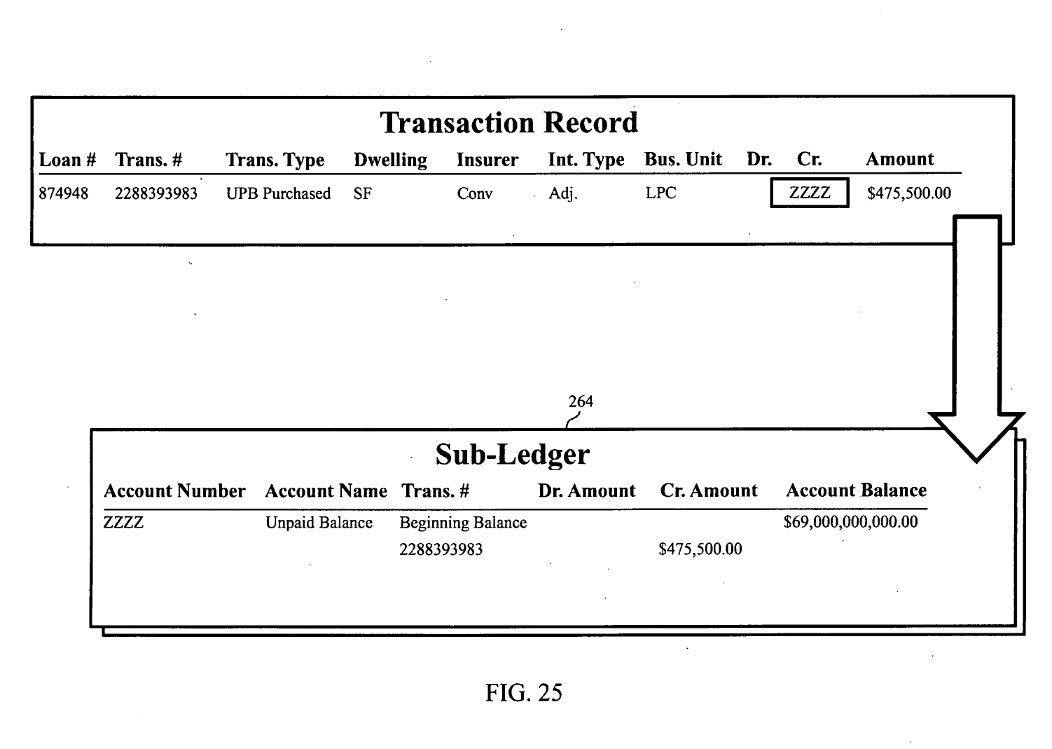

Referring to FIG. 25, once the transaction has been associated with the appropriate credit and debit account numbers, the next step is to journalize the transaction onto the sub-ledger under the appropriate account numbers. As shown in FIG. 25, the amount of the transaction is placed on the sub-ledger 264. In this example, $475,500.00 is credited to the account ZZZZ on the sub-ledger 264.

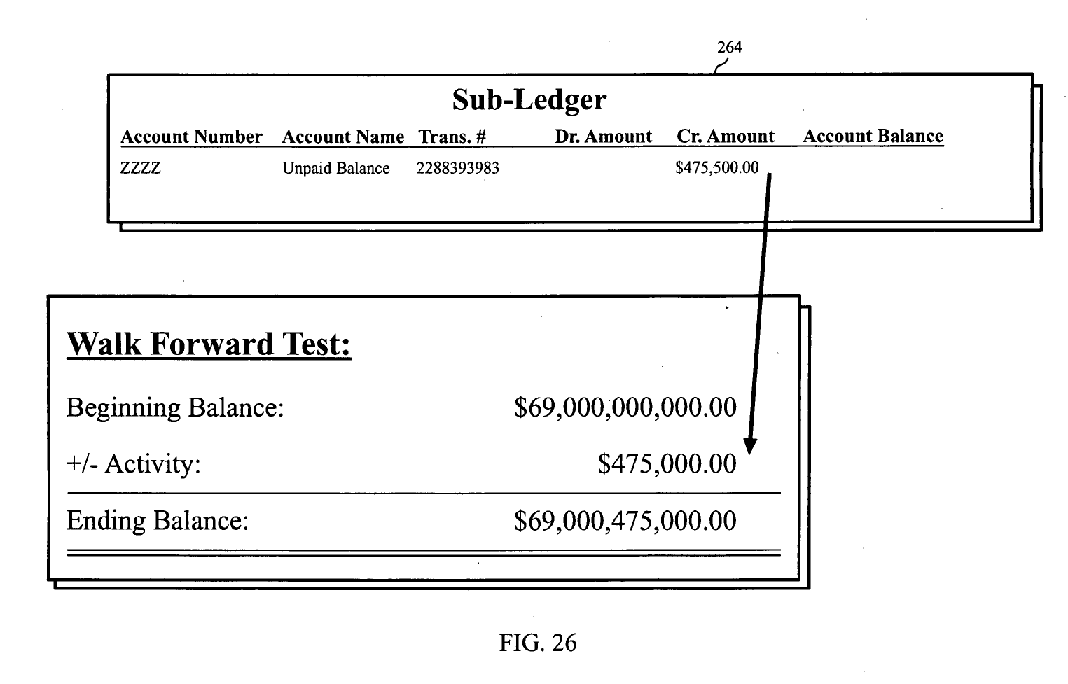

In FIG. 26, the accounting logic 256 performs a walk forward test on the sub-ledger 264 to determine if there are any problems with the transaction. If the beginning balance plus or minus the transaction equals the ending balance then no problem is identified. However, if the beginning balance plus or minus the transaction does not equal the ending balance then a problem is identified and a user is notified.

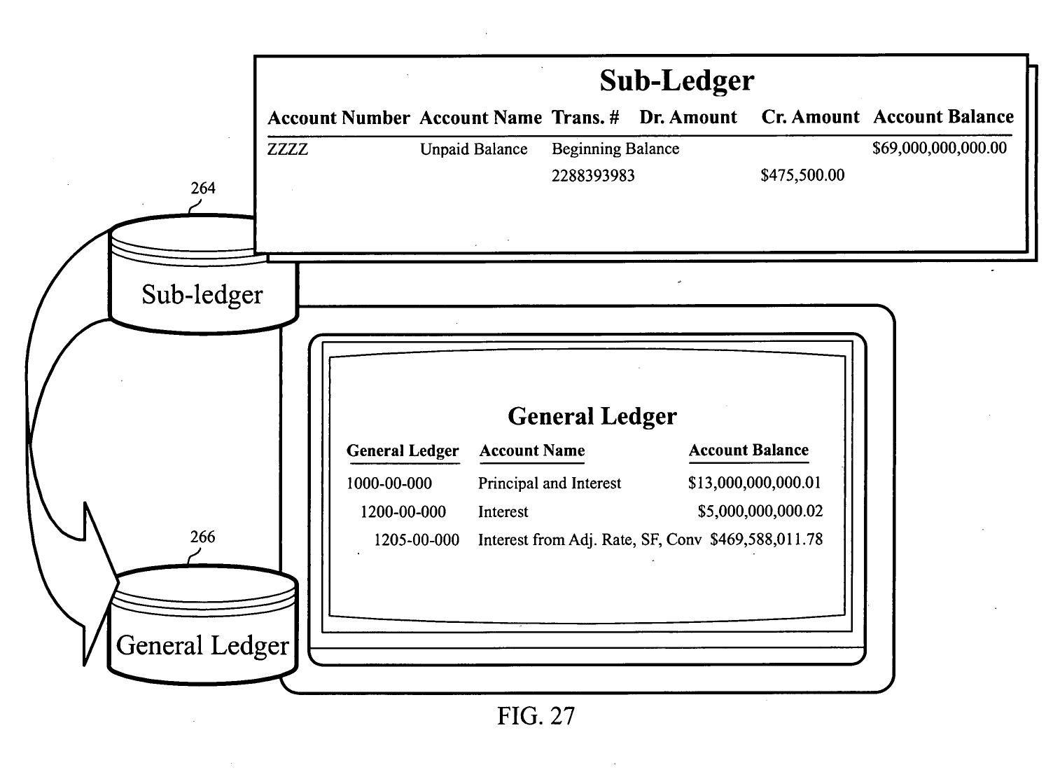

In FIG. 27, the sub-ledger activity is summarized posted to the general ledger 266. Typically, this is done at the end of the accounting cycle, which, as mentioned above, is assumed to be monthly.

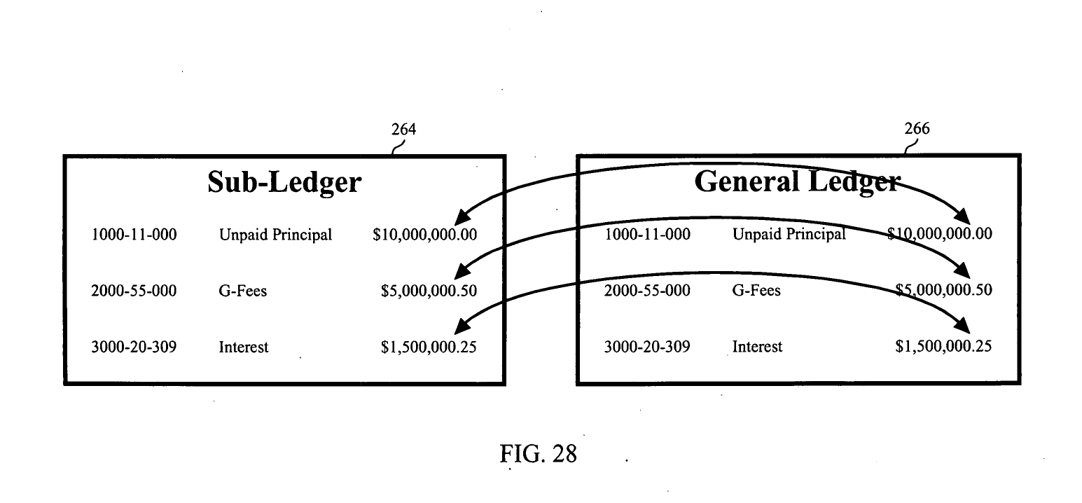

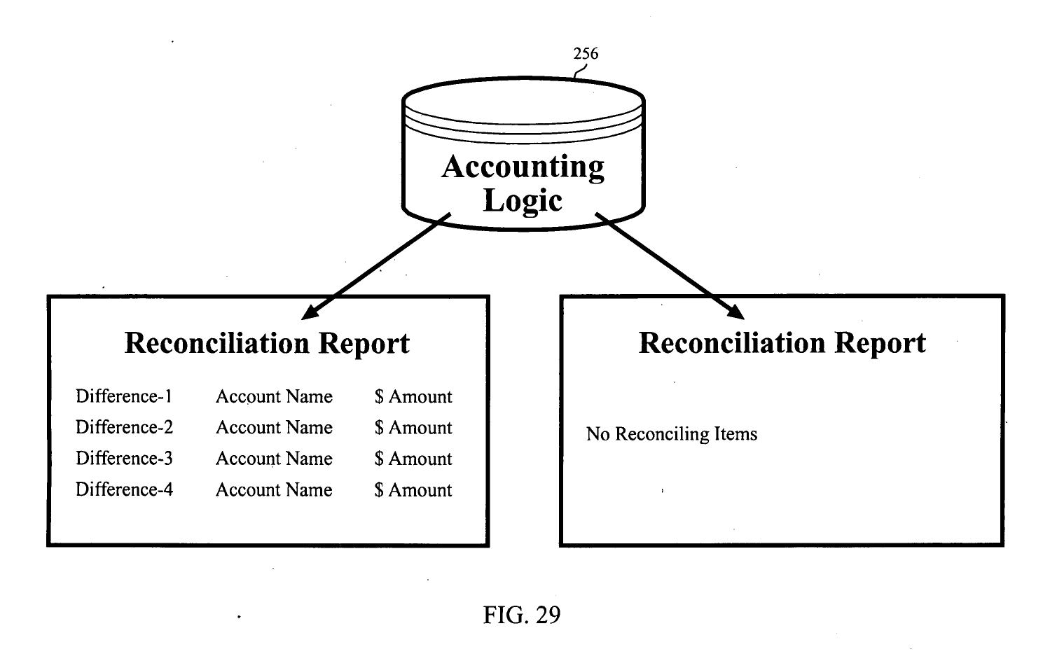

In FIGS. 28 and 29, the accounting logic reconciles the sub-ledger 264 and the general ledger 266. This is done by comparing the entries on the sub-ledger 264 to the entries on the general ledger 266 to determine if there are any discrepancies. Any discrepancies are reported to a user to determine the cause of the discrepancy as shown in FIG. 29. In the example, there are no discrepancies and, therefore, there are no items to reconcile.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

1. A method of accounting for a mortgage related transaction, the method comprising:
receiving data related to the mortgage related transaction, the mortgage related transaction being defined using a combination of attributes;
comparing the combination of attributes that define the transaction with a database of attribute combinations to determine the accounting treatment of the transaction.

2. The method of claim 1, wherein the method comprises associating at least one of a debit and credit account with the mortgage related transaction based on the combination of attributes.

3. The method of claim 2, wherein associating the at least one of a debit and credit account with the transaction comprises determining at least one of a debit and credit account associated with the combination of attributes in the database that correspond to the combination of attributes that define the transaction and associating the at least one of a debit and credit account associated with the combination of attributes in the database to the combination of attributes that define the transaction.

4. The method of claim 1, further comprising determining the combination of attributes that define the transaction.

5. The method of claim 1, wherein the mortgage related transaction comprises transactions related to receiving a mortgage payment and/or forming and/or accounting for mortgage backed securities.

6. The method of claim 1, further comprising recording the transaction to a ledger and reconciling the ledger by adjusting one or more account balances based on the transaction and comparing the adjusted balance to the balance before the balance was adjusted.

7. The method of claim 1, further comprising defining a plurality of types of loan products using a plurality of attributes, wherein the different types of loan products are defined using different combinations of the plurality of attributes and/or different values for selected ones of the plurality of attributes.

8. The method according to claim 7, further including identifying which attributes are present in a particular loan and processing the mortgage related transaction in accordance with the attributes present in the particular loan.

9. The method according to claim 8, wherein processing the data associated with the particular loan includes processing the data without reference to a product type designation apart from the plurality of attributes and/or the different values for the selected ones of the plurality of attributes.

10. The method according to claim 7, further including processing data associated with a loan received as part of a configurable data stream, the configurable data stream being capable of transmitting data associated with a plurality of predefined attributes and data associated with attributes having characteristics defined in the configurable data stream.

11. The method according to claim 7, further including defining a default set of attributes associated with a default mortgage product.

12. The method according to claim 11, further including defining one or more additional attributes that are not part of the default set of attributes, the additional attributes being associated with one or more product features that are not part of the default mortgage product.

13. The method according to claim 7, further including determining purchase prices for loan products and yield adjustments for at least some of the plurality of attributes, the yield adjustments being usable to adjust a base price to arrive at the purchase price for a particular loan product.

14. The method according to claim 13, further including providing real-time or near-real time financial performance data to pricing models used to generate the yield adjustments, the financial performance data relating to financial performance of a plurality of loans processed by the data processing system.

15. A method of accounting for a mortgage related transaction, comprising:
receiving data pertaining to the mortgage related transaction, the mortgage related transaction being defined as a combination of attributes;
comparing the combination of attributes of the transaction to an accounting matrix, the accounting matrix comprising a plurality of groups and a plurality of values for each group, the combination of attributes of the transaction being used to determine a corresponding combination of groups and/or values for each group in the accounting matrix; and
classifying the transaction based on the results of comparing the attributes of the transaction to the accounting matrix.

16. The method of claim 15, comprising associating at least one of a credit account and a debit account with the transaction based on the results of comparing the attributes of the transaction to the accounting matrix.

17. The method of claim 15, wherein a debit and a credit account is associated with a majority of the possible combinations of groups and values in the accounting matrix.

18. The method of claim 15, comprising determining that the accounting matrix does not include a value that corresponds to an attribute of the transaction, and creating a new value to correspond to the attribute of the transaction responsive to operator inputs.

19. The method of claim 15, wherein the groups comprise at least two of the following: transaction type, dwelling type, insurer, and interest type.

20. The method of claim 15, wherein each group in the accounting matrix is a single value for the transaction.

21. A data processing system for processing data regarding a plurality of different types of transactions, wherein the data processing system receives a plurality of types of transactions, the types of transactions each comprising a combination of attributes, and wherein the data processing system classifies the transactions for accounting purposes by comparing the attributes to a database which comprises a combinations of attributes.

22. The data processing system of claim 21, wherein the data processing system associates at least one of a credit and debit account with the transactions based on the combination of attributes.

23. The data processing system of claim 21, wherein the data processing system determines the plurality of attributes and classifies the transactions upon receipt of the data.

24. The data processing system of claim 21, wherein the transactions comprise transactions related to receiving a mortgage payment and/or forming and/or accounting for mortgage backed securities.

25. A data processing system for processing data regarding mortgage related transactions, the system comprising:
an accounting matrix which includes groups of accounting relevant transaction attributes and/or loan attributes, the groups including values representing the attributes, wherein each combination of groups and values is associated with at least one of a debit account and a credit account; and
accounting logic which determines the attributes of a mortgage related transaction and maps the attributes to the groups in the accounting matrix, the accounting logic using the map of the attributes to the groups to classify the transaction for accounting purposes.

26. The data processing system of claim 25, further comprising reporting logic, the reporting logic including logic which is used to receive accounting information from the accounting logic and create output regarding accounting activities for a period of time.

27. The data processing system of claim 25, further comprising reconciliation logic, the reconciliation logic being used to reconcile a subsidiary ledger and a general ledger, wherein at least one of the subsidiary ledger and the general ledger are used by the accounting logic to record a mortgage related transaction.

28. The data processing system of claim 25, wherein the accounting logic associates at least one of a credit account and a debit account with the transaction based on the results of mapping the attributes of the transaction to the accounting matrix.

29. A data processing system comprising:
a database which includes a plurality of groups each of which comprises a plurality of mortgage related transaction values, wherein the groups and values are used define attribute combinations each of which is associated with a type of mortgage related transaction, and wherein the database is used to classify transactions for accounting purposes that are received by the system; and
a user interface which receives user inputs to modify the database.

30. The data processing system of claim 29, wherein the user interface receives user inputs to add a new value to a group.

31. The data processing system of claim 29, wherein the user interface receives user inputs to add a new group to the database.

32. The data processing system of claim 29, wherein each attribute combination is associated with at least one account, and wherein the user interface receives user inputs to modify the at least one account that is associated with one of the attribute combinations.

33. A data processing system, comprising:
a data storage system configured to store loan data related to the plurality of loans;
acquisition logic, the acquisition logic including logic configured to receive information pertaining to loan term, interest rate, principal owed and other parameters for a plurality of loans;
a user interface configured to receive servicer loan data including loan activity data, the servicer loan data being received from a servicer of one or more of the plurality of loans, the user interface including one or more web pages;
accounting logic, which is configured to receive and process the servicer loan data, the accounting logic being configured to classify, for accounting purposes, the servicer loan data based on the attributes of the servicer loan data; and
financial asset generation logic, the financial asset generation logic including logic configured to facilitate creation and maintenance of a plurality of financial assets backed by the plurality of loans,
wherein the acquisition logic, the accounting logic, and the financial asset generation logic are provided on a common integrated data processing platform.

34. The data processing system of claim 33, wherein the accounting logic is configured to compare the attributes of the servicer loan data to a database of attribute combinations.

35. The data processing system of claim 33, wherein the accounting logic comprises an accounting matrix and the attributes of the servicer loan data are mapped to the accounting matrix to determine the appropriate accounting treatment of the servicer loan data.
